(19) United States
(12) Patent Application Publication
(10) Pub. No.: US 2013/0053261 A1
(43) Pub. Date: Feb. 28, 2013

(54) GENES DIFFERENTIALLY EXPRESSED BY CUMULUS CELLS AND ASSAYS USING SAME TO IDENTIFY PREGNANCY COMPETENT OOCYTES

(71) Applicants: Jose B. Cibelli, East Lansing, MI (US); Amy E. Iager, Ada, MI (US); Hasan H. Otu, Istanbul (TR)

(72) Inventors: Jose B. Cibelli, East Lansing, MI (US); Amy E. Iager, Ada, MI (US); Hasan H. Otu, Istanbul (TR)

(21) Appl. No.: 13/509,111

(22) PCT Filed: Nov. 10, 2010
(86) PCT No.: PCT/US10/56252

§ 371 Date: Nov. 16, 2012

Related U.S. Application Data
(60) Provisional application No. 61/259,783, filed on Nov. 10, 2009.
(60) Provisional application No. 61/360,556, filed on Jul. 1, 2010.
(60) Provisional application No. 61/387,286, filed on Sep. 28, 2010.
(60) Provisional application No. 61/387,313, filed on Sep. 28, 2010.
(60) Provisional application No. 61/388,296, filed on Sep. 30, 2010.

(51) Int. Cl. C40B 30/04

(52) U.S. Cl. 506/9

(57) ABSTRACT

A genetic means of identifying “pregnancy competent” oocytes is provided. The means comprises detecting the level of expression of one or more genes that are expressed at characteristic levels (upregulated or downregulated) in cumulus cells derived from pregnancy competent oocytes. This characteristic gene expression level, or pattern referred to herein as the “pregnancy signature”, also can be used to identify subjects with under-lying conditions that impair or prevent the development of a viable pregnancy, e.g., pre-menopausal condition, other hormonal dysfunction, ovarian dysfunction, ovarian cyst, cancer or other cell proliferation disorder, autoimmune disease and the like. In preferred embodiments the pregnancy signature will comprise one or more of AB-CA6, NCAM1, OLFML3, PTPRA, SDF4, GPR137B, DDIT4, DUSP1, GPR137B, IDUA, KCTD5, NDNL2, SLC26A3, and TERF2IP.

### CROSS REFERENCE TO RELATED APPLICATIONS

This application claims priority to U.S. provisional application Ser. No. 61/388,296 filed Sep. 30, 2010; U.S. provisional application Ser. No. 61/387,313 and 61/387,286 both filed Sep. 28, 2010; U.S. provisional application Ser. No. 61/360,556 filed on Jul. 1, 2010 and U.S. provisional application Ser. No. 61/259,783 filed on Nov. 10, 2009. This application also relates to U.S. Ser. No. 11/584,580 filed on Oct. 23, 2006 which is a continuation in part of U.S. Ser. No. 11/437,797 filed on May 22, 2006, which is in turn a continuation-in-part of U.S. Ser. No. 11/091,883 filed on Mar. 29, 2005. and which in turn claims the benefit of provisional application No. 60/556,875 filed Mar. 29, 2004. All of these applications are incorporated herein by reference in their entirety.

### FIELD OF THE INVENTION

The present invention identifies a genus of 227 human genes, as well as a preferred set of 14 genes, the expression of which on cumulus cells correlates to whether an oocyte that is associated with said cumulus cell, or which is obtained from the same donor, are pregnancy competent, i.e., capable of resulting in a viable pregnancy upon in vitro fertilization. In addition the present invention provides gene expression detection methods and statistical analysis methods that resulted in the identification of these 227 genes and the identification of the preferred set of 14 genes the expression of which on cumulus cells correlates to oocyte competency.

Based on this discovery, the present invention provides methods and test kits for identifying human oocytes which are potentially suitable for use in IVF procedures by detecting the level of expression of one or more of these 227 genes, or one or more of these 14 genes, by a cumulus cell associated with said oocyte or derived from the same donor. In addition, based on this discovery the invention further provides test kits for the identification of human oocytes that when fertilized and when transferred to a suitable uterine environment are more likely, to yield a viable pregnancy. The set of 227 genes, the expression of which on cumulus cells correlates to pregnancy potential are contained in Table 4 infra In addition the preferred set of 14 genes are found in Table 12 and consist of ABCA6, DDIT4, DUSP1, GPR137B, IDUA, KCTD5, KRAS, NCAM1, NDNL2, OLFML3, PTPRA, SDF4, SLC26A3, and TERF2IP.

Based on the foregoing, the present invention further provides genetic methods of identifying female subjects, preferably human females, having impaired fertility function, e.g., as a result of impaired ovarian function because of age (menopause), underlying disease condition or drug therapy by analyzing the expression of one or more of these 227 specific genes contained in Table 4 or the preferred set of 14 genes on cumulus cells obtained from oocytes isolated from said female subject.

Also, the invention provides methods of evaluating the efficacy of a putative fertility or hormonal treatment by assessing its effect on the expression of one or more of these 227 or 14 specific genes by cumulus cells of a female subject receiving this fertility or hormonal treatment.

### BACKGROUND OF THE INVENTION

Currently, there is no reliable commercially available genetic or non-genetic procedure for identifying whether a female subject produces oocytes that are “pregnancy competent”, i.e., oocytes which when fertilized by natural or artificial means are capable of giving rise to embryos that in turn are capable of yielding viable offspring when transferred to an appropriate uterine environment. Rather, conventional fertility assessment methods assess fertility e.g., based on hormonal levels, visual inspection of numbers and quality of oocytes, surgical or non-invasive (MRI) inspection of the female reproduction system organs, and the like. Often, when a woman has a problem in producing a viable pregnancy after a prolonged duration, e.g., more than a year, the diagnosis may be an “unexplained” fertility problem and the woman advised to simply keep trying or to seek other options, e.g., adoption or surrogacy.

Perhaps in part of the lack of a means for identifying pregnancy competent oocytes, the success rate for assisted reproductive technology (ART), pregnancy and birth rates following in vitro fertilization (IVF) attempts remain low. Subjective morphological parameters are still a primary criterion to select healthy embryos used for in IVF and ICSI programs. However, such criteria do not truly predict the competence of an embryo. Many studies have shown that a combination of several different morphologic criteria leads to more accurate embryo selection. Morphological criteria for embryo selection are assessed on the day of transfer, and are principally based on early embryonic cleavage (25-27 h post insemination), the number and size of blastomeres on day two, day three, or day five, fragmentation percentage and the presence of multi-nucleation in the 4 or 8 cell stage (Fenwick et al., Hum Reprod, 17, 407-12. (2002).

A recent study has shown that the selection of oocytes for insemination does not improve outcome of ART as compared to the transfer of all available embryos, irrespective of their quality (La Sala et al., Fertil Steril. (2008)).

There is a need to identify viable embryos with the highest implantation potential to increase IVF success rates, reduce the number of embryos for fresh replacement and lower multiple pregnancy rates. For all these reasons, several biomarkers for embryo selection are currently being investigated (Haouzi et al., Gynecol Obstet Fertil, 36, 730-742. (2008); He et al., Nature, 444, 12-3. (2006)).

As embryos that result in pregnancy differ in their metabolic profiles compared to embryos that do not, some studies are trying to identify a molecular signature that can be detected by non-invasive evaluation of the embryo culture medium (Brison et al., Hum Reprod, 19, 2319-24. (2004); Gardner et al., Fertil Steril, 76, 1175-80. (2001); Sakkas and Gardner, Curr Opin Obstet Gynecol, 17, 283-8 (2005); Seli et al., Fertil Steril, 88, 1350-7. (2007); Zhu et al. Fertil Steril. (2007).

Genomics are also providing vital knowledge of genetic and cellular function during embryonic development. McKenzie et al., Hum Reprod, 19, 2869-74. (2004); Feuerstein et al., Hum Reprod, 22, 3069-77 have reported, that the expression of several genes in cumulus cells, such as cyclooxygenase 2 (COX2), was indicative of oocyte and embryo quality. In addition Gremlin 1 (GREM1), hyaluronic acid synthase 2 (HAS2), steroidogenic acute regulatory protein (STAR), stearoyl-coenzyme A desaturase 1 and 5 (SCD1 and 5), amphiregulin (AREG) and pentraxin 3 (PTX3) have also been reported to be positively correlated with embryo quality (Zhang et al., Fertil Steril, 83 Suppl 1, 1169-79. (2005)). More recently, the expression of glutathione peroxidase 3 (GPX3), chemokine receptor 4 (CXCR4), cyclin D2 (CCND2) and catenin delta 1 (CTNNDD in human cumulus cells have been shown to be inversely correlated with embryo quality, based on early-cleavage rates during embryonic development (van Montfoort et al., (2008) Mol Hum Reprod, 14, 157-68.(2008)).

Also Cillo et al., Reprod. 134:645-50 (2007) suggests a correlation between the expression of certain cumulus genes, i.e., HAS2, GREM1 and PTX3 and oocyte quality and embryo development. Still further Assidi et al. Biol. Reprod. 79(2) 209-222 (2008) suggest a correlation as to the expression of certain cumulus genes, i.e., EGFR, CD44, HAS2, PTSG2 and BTC and oocyte quality and development of embryos therefrom. Further, Bettegowda et al., Biol. Reprod. 79(2):301-309 (2008) suggest a correlation as to the expression of certain proteinase cathepsin genes and bovine oocyte quality and development of offspring therefrom.

In addition, a patent was recently issued to Zhang et al. (Aug. 11, 2009) claims the detection of pentraxin 3 and a BCL-2 member on cumulus cells to assess oocyte quality. Also, US20040058975 published on Mar. 25, 2004 teaches that antagonism of the EP2 receptor and/or cycloxygenase COX-2 promotes cumulus cell proliferation and oocyte development.

Also, while early cleavage has been shown to be a reliable biomarker for predicting pregnancy (Lundin et al, Hum Reprod, 16, 2652-7. (2001); Van Montfoort et al., Hum Reprod, 19, 2103-8 (2004; Yang et al, Fertil Steril, 88, 1573-8 (2007)), little has been reported correlating gene expression profiles of cumulus cells with respect to pregnancy outcome (but see Assou et al., Mol Hum Reprod. 2008 December; 14(12):711-9. Epub 2008 Nov. 21).

Therefore, notwithstanding the foregoing, providing alternative and more predictive methods for identifying oocytes suitable for use in IVF procedures and in identifying the genetic bases of fertility problems in women would be highly desirable. In particular an identification of other genes, and biomarkers, the expression of which by cumulus cells correlates to pregnancy competency of oocytes and test kits and assays using same would be highly desirable as this could enhance the outcome of IVF procedures.

These methods and test kits would in addition provide for the identification of women with oocyte related fertility problems, which is desirable as such fertility problems may correlate to other health issues that preclude pregnancy, e.g., cancer, menopausal condition, hormonal dysfunction, ovarian cyst, or other underlying disease or health related problems.

### BRIEF DESCRIPTION AND OBJECTS OF THE INVENTION

The present invention relates to a method for selecting a competent oocyte, comprising a step of measuring the expression level of one of 227 genes in Table 4 or the 14 genes selected from the group consisting of ABCA6, DDIT4, DUSP1, GPR137B, IDUA, KCTD5, KRAS, NCAM1, NDNL2, OLFML3, PTPRA, SDF4, SLC26A3, and TERF2IP.

The present invention also relates to a method for selecting a competent embryo, comprising a step of measuring the expression level of specific genes in a cumulus cell surrounding the embryo, wherein said genes are those in Table 4 or the 14 genes selected from the group consisting of ABCA6, DDIT4, DUSP1, GPR137B, IDUA, KCTD5, KRAS, NCAM1, NDNL2, OLFML3, PTPRA, SDF4, SLC26A3, and TERF2IP.

The present invention also relates to a method for selecting a competent oocyte or a competent embryo, comprising a step of measuring in a cumulus cell surrounding said oocyte or said embryo the expression level of one or more genes selected from the 227 genes in Table 4 or the 14 genes selected from the group consisting of ABCA6, DDIT4, DUSP1, GPR137B, IDUA, KCTD5, KRAS, NCAM1, NDNL2, OLFML3, PTPRA, SDF4, SLC26A3, and TERF2IP.

Aberrant expression levels of one or more of these genes are predictive of a non competent oocyte or embryo due to early embryo arrest.

As discussed infra, it has been found that the level of expression of these genes by a cumulus cell of a woman donor correlates to the likelihood that an oocyte associated with said cumulus cell or derived from the same subject are “pregnancy competent” when fertilized by natural or artificial means. These genes and expression levels constitute what Applicants refer to as the “pregnancy signature”. In addition the pregnancy signature may further include one or more of the genes disclosed in Applicant's prior applications identified supra.

It is a related object of the invention to provide a novel method of determining whether an individual has a genetic associated fertility problem which potentially renders the individual's oocytes unsuitable for use in IVF methods based on the detected level of expression of one or more genes or corresponding polypeptides which constitute the “pregnancy signature.” The genes and gene products which constitute the pregnancy signature are again preferably selected from those contained in Table 4 and/or are selected from the group consisting of ABCA6, DDIT4, DUSP1, GPR137B, IDUA, KCTD5, ERAS, NCAM1, NDNL2, OLFML3, PTPRA, SDF4, SLC26A3, and TERF2IP.

It is another object of the invention to provide a method of evaluating the efficacy of a female fertility treatment which comprises:

(i) treating a female subject putatively having a problem that prevents or inhibits her from having a “viable pregnancy” and

(ii) isolating at least one oocyte from said female subject and cells associated therewith after said fertility treatment;

(iii) isolating at least one cumulus cell associated with said isolated oocyte, and detecting the level of expression of at least one gene selected from those in Table 4 or at least one gene selected from ABCA6, DDIT4, DUSP1, GPR137B, IDUA, KCTD5, KRAS, NCAM1, NDNL2, OLFML3, PTPRA, SDF4, SLC26A3, and TERF2IP that is expressed at a characteristic level of expression in “pregnancy competent” oocytes; and

(iv) determining the putative efficacy of said fertility treatment based on whether said gene is expressed at a level characteristic of “pregnancy competent” oocytes as a result of treatment.

It is another specific object of the invention to provide novel methods of treating infertility by modulating the expression of one or more genes that constitute the pregnancy signature. These methods include the administration of compounds that agonize or antagonize the expression of one or more of the genes contained in Table 4 or ABCA6, DDIT4, DUSP1, GPR137B, IDUA, KCTD5, KRAS, NCAM1, NDNL2, OLFML3, PTPRA, SDF4, SLC26A3, and TERF2IP and their splice or allelic variants.

It is another object of the invention to provide animal models for evaluating the efficacy of putative fertility treatments comprising identifying genes which are expressed at characteristic levels in cumulus cells associated with pregnancy competent oocytes of a non-human animal, e.g., a non-human primate; and assessing the efficacy of a putative fertility treatment in said non-human animal based on its effect on said gene expression levels, i.e., whether said treatment results in said gene expression levels better mimicking gene expression levels observed in cumulus cells associated with pregnancy competent oocytes, (“pregnancy signature”). i.e. one or more of the 227 genes in Table 4 or one or more of the 14 gene genus consisting of ABCA6, DDIT4, DUSP1, GPR137B, IDUA, KCTD5, ERAS, NCAM1, NDNL2, OLFML3, PTPRA, SDF4, SLC26A3, and TERF2IP.

### DETAILED DESCRIPTION OF THE FIGURES

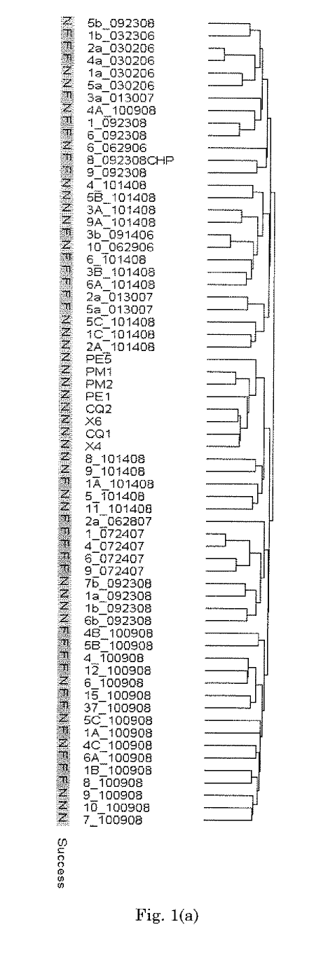

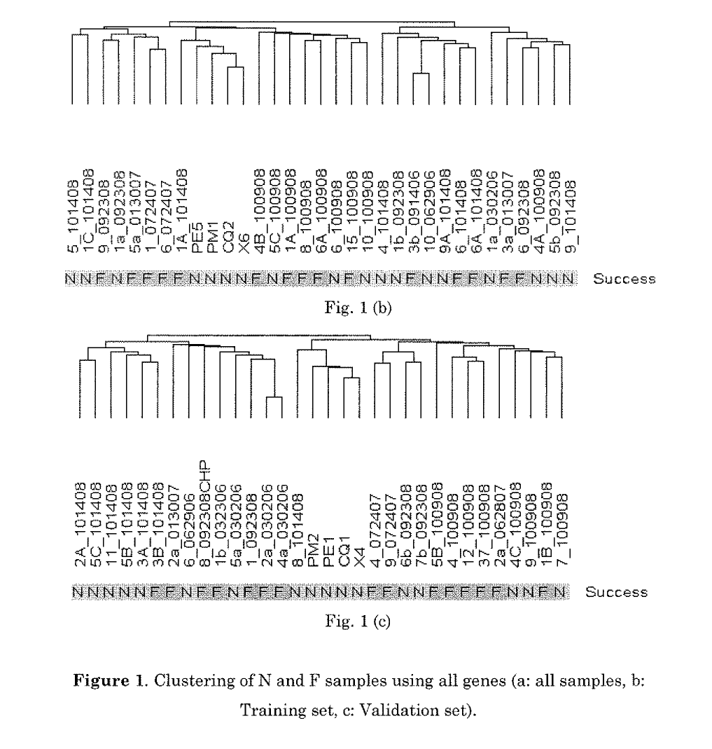

In FIG. 1a-c, the inventors separately show the clustering of all F and N samples (65 samples), training set samples (33 samples), and validation set samples (32 samples) using all genes (a: all samples, b: Training set, c: Validation set). Samples are clustered with hierarchical clustering utilizing average linkage method using Pearson's correlation as the metric of similarity following row normalization Sneath, P. (1973) Numerical taxonomy; the principles and practice of numerical classification. W.H. Freeman, San Francisco, Calif. USA. FIG. 1: Clustering of N and F samples using all genes (a: all samples, b: Training set, c: Validation set).

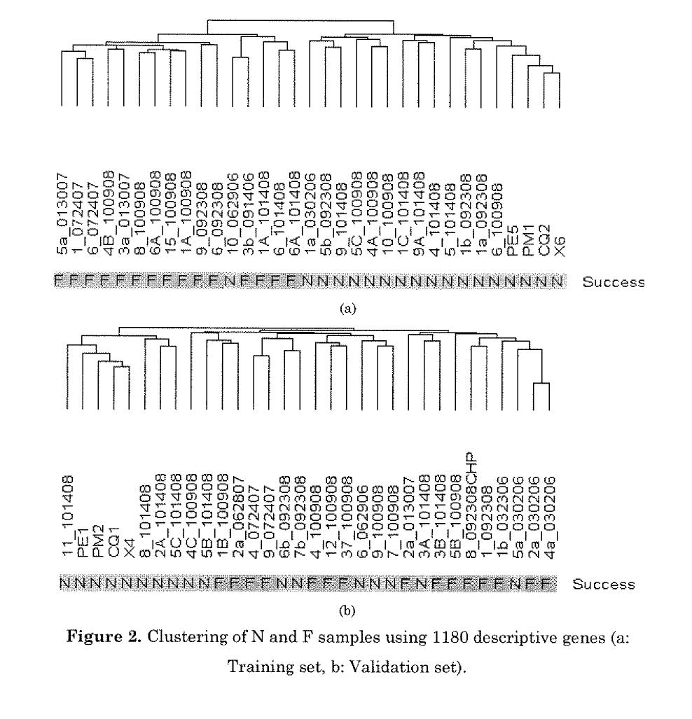

FIG. 2a-b: shows the clustering of N and F samples using 1180 descriptive genes (a: Training set, b: Validation set). The results therein show differential expression based on t-test (p<0.05 with Bonferroni correction for multiple hypothesis testing) which were identified in the training set (F vs. N). Resulting 1180 genes, called “descriptive genes”, were used to cluster Training and Validation sets separately.

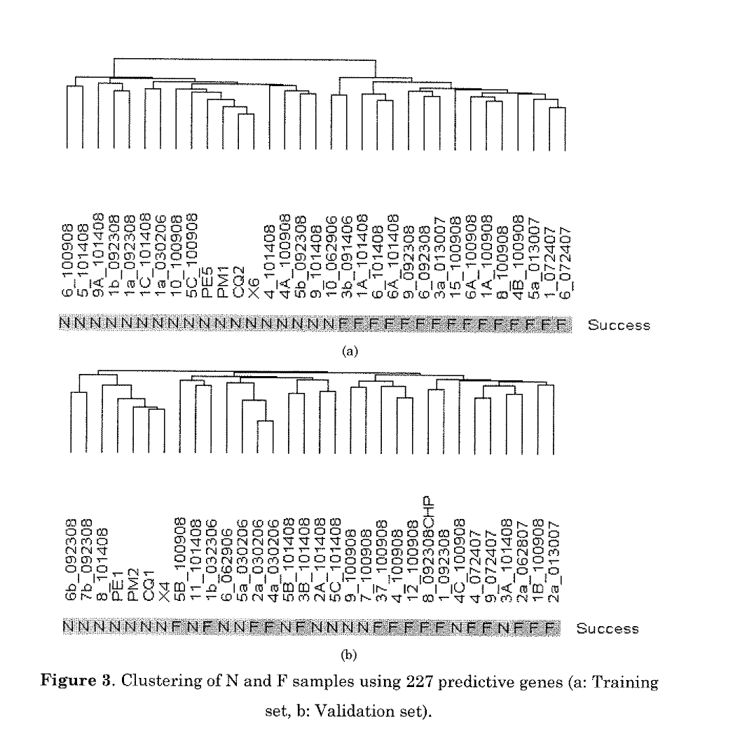

FIG. 3 shows the clustering of N and F samples using 227 predictive genes (a: Training set, b: Validation set). The data reveals that the only sample incorrectly predicted in the training set is misplaced in the clustering as well, however, the mixed behavior of F and N samples in validation set clustering emphasizes the contribution made by the weighted voting approach.

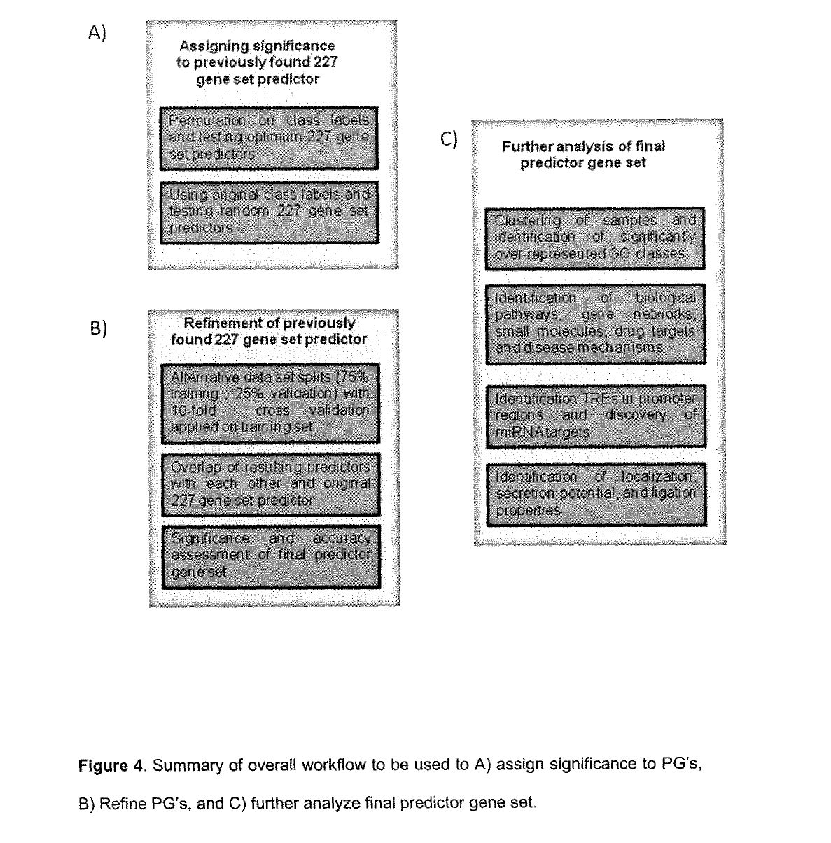

FIG. 4 schematically depicts methods to A) assign significance to the predictor gene set (PG's) in Table 4, B) Refine PG's, and C) further analyze final predictor gene set

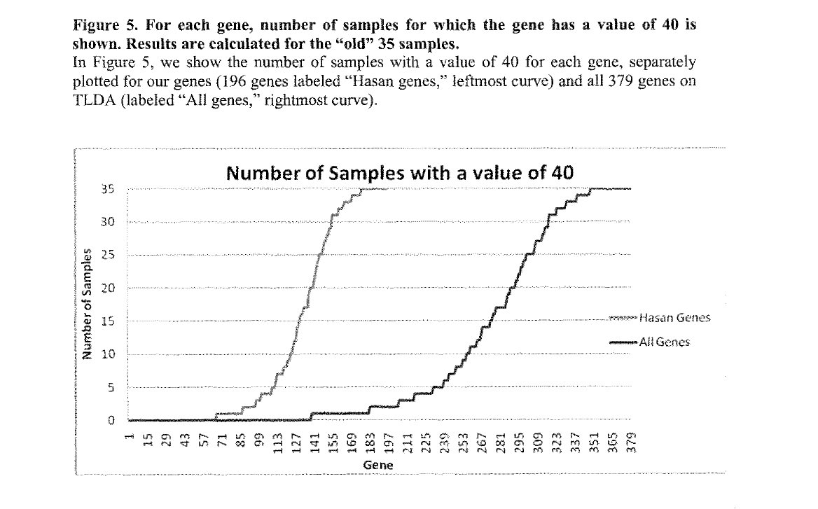

FIG. 5. For each gene, number of samples for which the gene has a value of 40 is shown. Results are calculated for the “old” 35 samples. In FIG. 5, we show the number of samples with a value of 40 for each gene, separately plotted for our genes (196 genes labeled “Hasan genes”) and all 379 genes on TLDA (labeled “All genes”).

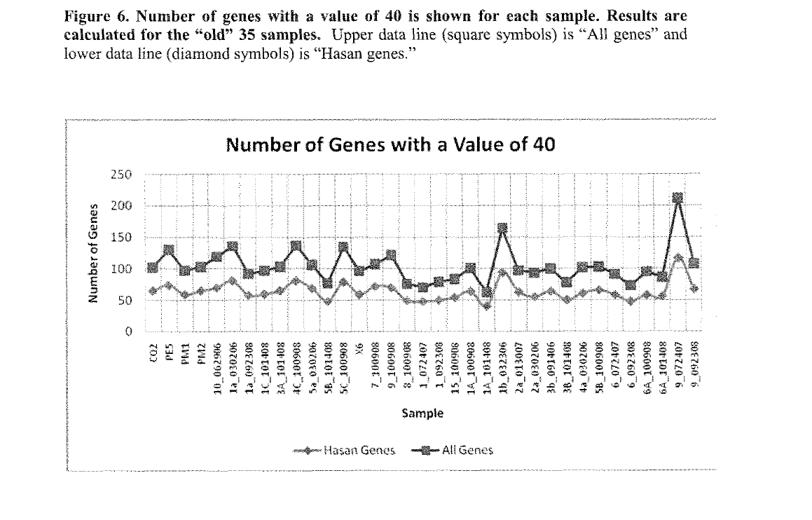

FIG. 6. Number of genes with a value of 40 is shown for each sample. Results are calculated for the “old” 35 samples: For each gene, number of samples for which the gene has a value of 40 is shown. Results are calculated for the “new” 14 samples.

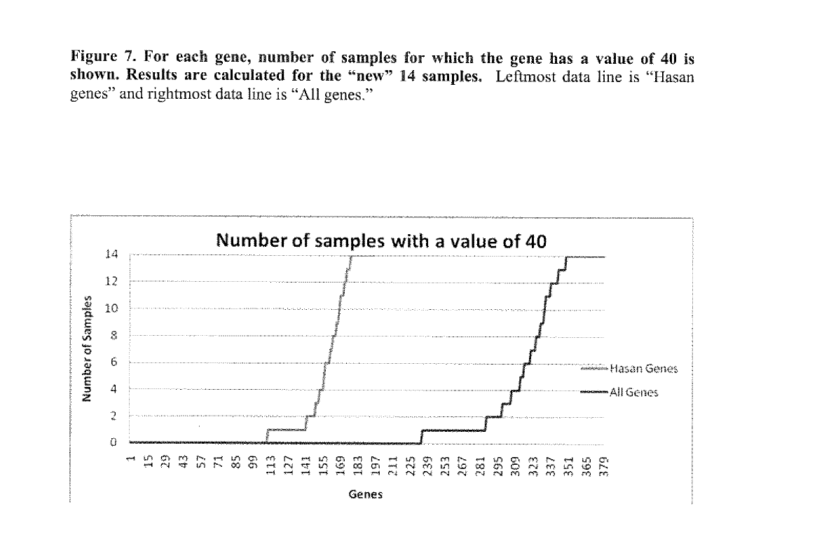

FIG. 7. For each gene, number of samples for which the gene has a value of 40 is shown. Results are calculated for the “new” 14 samples.

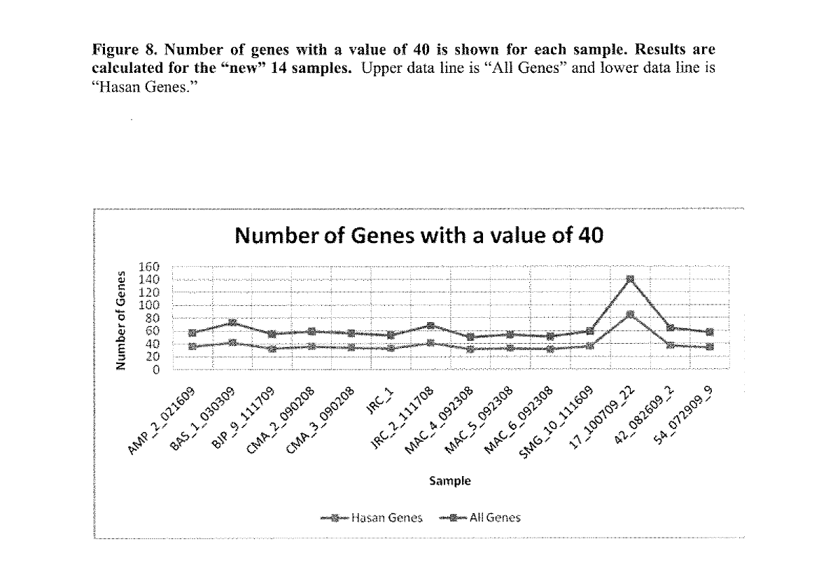

FIG. 8. Number of genes with a value of 40 is shown for each sample. Results are calculated for the “new” 14 samples.

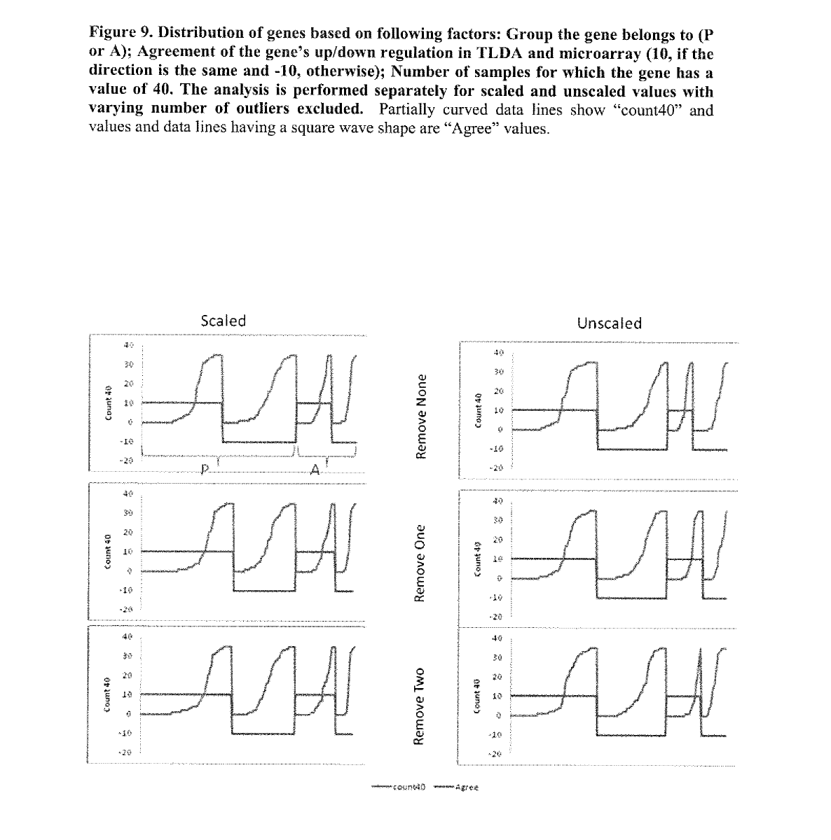

FIG. 9: Distribution of genes based on following factors: Group the gene belongs to (P or A); Agreement of the gene's up/down regulation in TLDA and microarray (10, if the direction is the same and −10, otherwise); Number of samples for which the gene has a value of 40. The analysis is performed separately for scaled and unsealed values with varying number of outliers excluded

### DETAILED DESCRIPTION OF THE INVENTION

Prior to discussing the invention in more detail, the following definitions are provided. Otherwise all words and phrases in this application are to be construed by their ordinary meaning, as they would be interpreted by an ordinary skilled artisan within the context of the invention.

“Pregnancy-competent oocyte”: refers to a female gamete or egg that when fertilized by natural or artificial means is capable of yielding a viable pregnancy when it is comprised in a suitable uterine environment.

“The term “competent embryo” similarly refers to an embryo with a high implantation rate leading to pregnancy. The term “high implantation rate” means the potential of the embryo when transferred in uterus, to be implanted in the uterine environment and to give rise to a viable fetus, which in turn develops into a viable offspring absent a procedure or event that terminates said pregnancy.

“Viable-pregnancy”: refers to the development of a fertilized oocyte when contained in a suitable uterine environment and its development into a viable fetus, which in turn develops into a viable offspring absent a procedure or event that terminates said pregnancy.

“Cumulus cell” refers to a cell comprised in a mass of cells that surrounds an oocyte. This is an example of an “oocyte associated cell”. These cells are believed to be involved in providing an oocyte some of its nutritional and or other requirements that are necessary to yield an oocyte which upon fertilization is “pregnancy competent” (Buccione, R., Schroeder, A. C., and Eppig, J. J. (1990). Interactions between somatic cells and germ cells throughout mammalian oogenesis. Biol Reprod 43, 543-547.)

“Differential gene expression” refers to genes the expression of which varies within a tissue of interest; herein preferably a cell associated with an oocyte, e.g., a cumulus cell.

“Real Time RT-PCR”: refers to a method or device used therein that allows for the simultaneous amplification and quantification of specific RNA transcripts in a sample.

“Microarray analysis”: refers to the quantification of the expression levels of specific genes in a particular sample, e.g., tissue or cell sample.

“Pregnancy signature”: herein refers to the normal level of expression of one or more genes or polypeptides that are selected or encoded by the specific genes in Table 4 or the 14 genes selected from the group consisting of ABCA6, DDIT4, DUSP1, GPR137B, IDUA, KCTD5, KRAS, NCAM1, NDNL2, OLFML3, PTPRA, SDF4, SLC26A3, and TERF2IP and their orthologs, splice or allelic variants wherein these genes or polypeptides are expressed in normal cumulus cells at levels which correlate to the likelihood that an oocyte that is associated with a cumulus cell which expresses said one or more genes or polypeptides at these characteristic levels are more likely to give rise to a viable pregnancy.

“Characteristic level of expression of a cumulus gene” herein with respect to a particular detected expressed nucleic acid sequence or polypeptide means that the particular gene or polypeptide is expressed at levels which are substantially similar to the levels observed in cumulus cells that are associated with a normal cumulus cell or one associated with a normal or developmentally competent oocyte.

By “substantially similar” is meant that the levels of expression of individual genes are preferably within the range of +/−1-5 fold of the level of expression by a normal cumulus cell, more preferably within the range of +/−1-3-fold, still more preferably within the range of +/−1-1.5 fold and most preferably within the range of +/−1.0-1.3, 1.0-1.2 or 1.0-1.2 fold of the detected levels of expression of the gene or polypeptide by a normal cumulus cell.

According to the invention, the oocyte may result from a natural cycle, a modified natural cycle or a stimulated cycle for cIVF or ICSI. The term “natural cycle” refers to the natural cycle by which the female or woman produces an oocyte. The term “modified natural cycle” refers to the process by which, the female or woman produces an oocyte or two under a mild ovarian stimulation with GnRH antagonists associated with recombinant FSH or hMG. The term “stimulated cycle” refers to the process by which a female or a woman produces one or more oocytes under stimulation with GnRH agonists or antagonists associated with recombinant FSH or hMG.

“Oocyte or cumulus cell determined to possess suitable pregnancy signature or to be pregnancy competent” refers to an oocyte or a cumulus cell associated with the oocyte or an oocyte derived from the same subject at around the same time (within 0-6 months) as the tested cumulus cell which has been determined to express at least one of the genes or polypeptides encoded by those in Table 4 or the 14 genes selected from the group consisting of ABCA6, DDIT4, DUSP1, GPR137B, IDUA, KCTD5, KRAS, NCAM1, NDNL2, OLFML3, PTPRA, SDF4, SLC26A3, and TERF2IP or an ortholog or splice or allelic variant thereof in a manner characteristic of the level of expression by a normal cumulus cell. Preferably at least 2 or 3 genes are expressed in a characteristic manner, more preferably at least 3-10 genes, 10-50 genes and even up to 100 genes or more of those contained in Table 4 or their allelic or splice variants. It should be understood that if the expression of numerous genes are evaluated in the subject genetic based assays, such as in the order of 10 or more, that a suitable pregnancy signature means that all or substantially all, i.e. at least 70-80% of the detected genes are expressed in a manner characteristic of a normal cumulus cell. For example if the expression of 10 genes is detected at least 7, 8 or 9 of the genes will preferably be expressed at the levels consistent with a normal cumulus cell, i.e. one associated with an oocyte capable of giving rise to a normal embryo and viable pregnancy.

In general with respect to the pregnancy signature the characteristic levels of expression is observed for at least 3-5, 5-10, 10 to 20, and potentially at least 50 to 100 genes, that are expressed at characteristic levels in cumulus cells, that surround “pregnancy competent” oocytes. This is intended to encompass the level at which the gene is expressed and the distribution of gene expression within cumulus cells analyzed.

“Pregnancy signature gene”: refers to a gene which is expressed at characteristic levels by a cumulus cell, which is associated with a normal or “pregnancy competent” oocyte. These genes are contained in Table 4 and further include the 14 genes selected from the group consisting of ABCA6, DDIT4, DUSP1, GPR137B, IDUA, KCTD5, KRAS, NCAM1, NDNL2, OLFML3, PTPRA, SDF4, SLC26A3, and TERF2IP and their orthologs, splice and allelic variants. In the table the genes are referenced by their name as well as Accession number. It should be understood that the invention further encompasses detection of allelic and splice variants of these genes and orthologs.

“Probe suitable for detection of the expression of a pregnancy signature gene or polypeptide” refers to a nucleic acid sequence or sequences or ligand such as an antibody that specifically detects the expression of the transcribed gene or corresponding polypeptide. In a preferred embodiment expression is selected by use of real time PCR detection methods.

“IVF”: refers to in vitro fertilization.

The term “classical in vitro fertilization” or “cIVF” refers to a process by which oocytes are fertilized by sperm outside of the body, in vitro. IVF is a major treatment in infertility when in vivo conception has failed. The term “intracytoplasmic sperm injection” or “ICSI” refers to an in vitro fertilization procedure in which a single sperm is injected directly into an oocyte. This procedure is most commonly used to overcome male infertility factors, although it may also be used where oocytes cannot easily be penetrated by sperm, and occasionally as a method of in vitro fertilization, especially that associated with sperm donation.

“Zona pellucida” refers to the outermost region of an oocyte.

“Method for detecting differential expressed genes” encompasses any known method for quantitatively evaluating differential gene expression using a probe that specifically detects for the expressed gene transcript or encoded polypeptide. Examples of such methods include indexing differential display reverse transcription polymerase chain reaction (DDRT-PCR; Mahadeva et al, 1998, J. Mol. Biol. 284:1391-1318; WO 94/01582; subtractive mRNA hybridization (See Advanced Mol. Biol.; R. M. Twyman (1999) Bios Scientific Publishers, Oxford, p. 334, the use of nucleic acid arrays or microarrays (see Nature Genetics, 1999, vol. 21, Suppl. 1061) and the serial analysis of gene expression. (SAGE) See e.g., Valculesev et al, Science (1995) 270:484.487) and real time PCR (RT-PCR). For example, differential levels of a transcribed gene in an oocyte cell can be detected by use of Northern blotting, and/or RT-PCR.

A referred method is the CRL amplification protocol refers to the novel total RNA amplification protocol disclosed in Applicant's earlier applications that combines template-switching PCR and T7 based amplification methods. This protocol is well suited for samples wherein only a few cells or limited total RNA is available.

Preferably, the “pregnancy signature” genes are detected by hybridization of RNA or DNA to DNA chips, e.g., filter arrays comprising cDNA sequences or glass chips containing cDNA or in situ synthesized oligonucleotide sequences. Filtered arrays are typically better for high and medium abundance genes. DNA chips can detect low abundance genes. In the exemplary embodiment the sample may be probed with Affymetrix GeneChips comprising genes from the human genome or a subset thereof.

Alternatively, polypeptide arrays comprising the polypeptides encoded by pregnancy signature genes or antibodies that bind thereto may be produced and used for detection and diagnosis.

“EASE” is a gene ontology protocol that from a list of genes forms subgroups based on functional categories assigned to each gene based on the probability of seeing the number of subgroup genes within a category given the frequency of genes from that category appearing on the microarray.

Based on the foregoing the present invention provides a novel method of detecting whether a female, preferably human or non-human mammal, produces “pregnancy competent” oocytes or whether a particular oocyte is pregnancy competent. The method involves detecting the levels of expression of one or more genes in Table 4 or the 14 genes selected from the group consisting of ABCA6, DDIT4, DUSP1, GPR137B, IDUA, KCTD5, KRAS, NCAM1, NDNL2, OLFML3, PTPRA, SDF4, SLC26A3, and TERF2IP that are expressed at characteristic levels by cumulus cells associated with (surrounding) oocytes that are “pregnancy competent”, i.e., these oocytes when fertilized by natural or artificial means (IVF), and transferred into a suitable uterine environment are capable of yielding a viable pregnancy, i.e., embryo that develops into a viable fetus and eventually an offspring unless the pregnancy is terminated by some event or procedure, e.g., a surgical or hormonal intervention.

As described herein the inventors have determined as set of genes expressed in cumulus cells that are biomarkers for embryo potential and pregnancy outcome. They demonstrated that genes expression profile of cumulus cells which surrounds oocyte correlated to different pregnancy outcomes, allowing the identification of a specific expression signature of embryos developing toward pregnancy. Their results indicate that analysis of cumulus cells surrounding the oocyte is a non-invasive approach for embryo selection.

The set of predictive genes in Table 4 and the 14 gene set identified in Table 12 are known human genes. However, the expression of these genes (on cumulus cells) had not heretofore been correlated to oocyte competency or embryo development. Therefore, this invention relates to a method for selecting a competent oocyte, comprising a step of measuring the expression level of specific genes in a cumulus cell surrounding said oocyte, wherein said genes include at least one of the 227 genes in Table 4 or the 14 genes selected from the group consisting of ABCA6, DDIT4, DUSP1, GPR137B, IDUA, KCTD5, KRAS, NCAM1, NDNL2, OLFML3, PTPRA, SDF4, SLC26A3, and TERF2IP.

The methods of the invention may further comprise a step consisting of comparing the expression level of the genes in the sample with a control, wherein detecting differential in the expression level of the genes between the sample and the control is indicative whether the oocyte is competent. The control may consist in sample comprising cumulus cells associated with a competent oocyte or in a sample comprising cumulus cells associated with an unfertilized oocyte.

The methods of the invention are applicable preferably to human women but may be applicable to other mammals (e.g., primates, dogs, cats, pigs, cows . . . ).

The methods of the invention are particularly suitable for assessing the efficacy of an in vitro fertilization treatment. Accordingly the invention also relates to a method for assessing the efficacy of a controlled ovarian hyperstimulation (COS) protocol in a female subject comprising: i) providing from said female subject at least one oocyte with its cumulus cells; ii) determining by a method of the invention whether said oocyte is a competent oocyte.

Then after such a method, the embryologist may select the competent oocytes and in vitro fertilize them, for example using a classical in vitro fertilization (cIVF) protocol or under an intracytoplasmic sperm injection (ICSI) protocol.

A further object of the invention relates to a method for monitoring the efficacy of a controlled ovarian hyperstimulation (COS) protocol comprising: i) isolating from said woman at least one oocyte with its cumulus cells under natural, modified or stimulated cycles; ii) determining by a method of the invention whether said oocyte is a competent oocyte; iii) and monitoring the efficacy of COS treatment based on whether it results in a competent oocyte.

The COS treatment may be based on at least one active ingredient selected from the group consisting of GnRH agonists or antagonists associated with recombinant FSH or hMG.

The present invention also relates to a method for selecting a competent embryo, comprising a step of measuring the expression level of at least one of the 227 genes in Table 4 or the 14 genes selected from the group consisting of ABCA6, DDIT4, DUSP1, GPR137B, IDUA, KCTD5, KRAS, NCAM1, NDNL2, OLFML3, PTPRA, SDF4, SLC26A3, and TERF2IP.

The methods of the invention may further comprise a step consisting of comparing the expression level of the genes in the sample with a control, wherein detecting differential in the expression level of the genes between the sample and the control is indicative whether the embryo is competent. The control may consist in sample comprising cumulus cells associated with an embryo that gives rise to a viable fetus or in a sample comprising cumulus cells associated with an embryo that does not give rise to a viable fetus.

It is noted that the methods of the invention leads to an independence from morphological considerations of the embryo. Two embryos may have the same morphological aspects but by a method of the invention may present a different implantation rate leading to pregnancy.

The methods of the invention are applicable preferably to human women but may be applicable to other mammals (e.g. primates, dogs, cats, pigs, cows . . . ).

The present invention also relates to a method for determining whether an embryo is a competent embryo, comprising a step consisting in measuring the expression level of 45 genes in a cumulus cell surrounding the embryo, wherein said genes include at least one of the 227 genes in Table 4 or the 14 genes selected from the group consisting of ABCA6, DDIT4, DUSP1, GPR137B, IDUA, KCTD5, KRAS, NCAM1, NDNL2, OLFML3, PTPRA, SDF4, SLC26A3, and TERF2IP.

The present invention also relates to a method for determining whether an embryo is a competent embryo, comprising: i) providing an oocyte with its cumulus cells; vitro fertilizing said oocyte; and iii) determining whether the embryo that results from step ii) is competent by determining by a method of the invention whether said oocyte of step i), is a competent oocyte.

The present invention also relates to a method for selecting a competent oocyte or a competent embryo, comprising a step of measuring in a cumulus cell surrounding said oocyte or said embryo the expression level of one or more genes selected from at least one of the 227 genes in Table 4 or the 14 genes selected from the group consisting of ABCA6, DDIT4, DUSP1, GPR137B, IDUA, KCTD5, KRAS, NCAM1, NDNL2, OLFML3, PTPRA, SDF4, SLC26A3, and TERF2IP. Aberrant expression of one or more of these genes selected may be predictive of a non competent oocyte or embryo, the inability of the embryo being unable to implant or of a non competent oocyte or embryo due to early embryo arrest.

The methods of the invention are particularly suitable for enhancing the pregnancy outcome of a female. Accordingly the invention also relates to a method for enhancing the pregnancy outcome of a female comprising: i) selecting a competent embryo by performing a method of the invention; iii) implanting the embryo selected at step i) in the uterus of said female, wherein said female may or may not be the oocyte donor.

The method as above described will thus help embryologist to avoid the transfer in uterus of embryos with a poor potential for pregnancy out come. The method as above described is also particularly suitable for avoiding multiple pregnancies by selecting the competent embryo able to lead to an implantation and a pregnancy.

In all above cases, the methods described the relationship between genes expression profile of cumulus cells and embryo and pregnancy outcomes.

Methods for determining the expression level of the genes of the invention:

Determination of the expression level of the genes in the “pregnancy signature” i.e., at least one of the 227 genes in Table 4 or at least one of the 14 genes selected from the group consisting of ABCA6, DDIT4, DUSP1, GPR137B, IDUA, KCTD5, KRAS, NCAM1, NDNL2, OLFML3, PTPRA, SDF4, SLC26A3, and TERF2IP. can be performed by a variety of techniques. Generally, the expression level as determined is a relative expression level.

More preferably, the determination comprises contacting the sample with selective reagents such as probes, primers or ligands, and thereby detecting the presence, or measuring the amount, of polypeptide or nucleic acids of interest originally in the sample. Contacting may be performed in any suitable device, such as a plate, microtitre dish, test tube, well, glass, column, and so forth. In specific embodiments, the contacting is performed on a substrate coated with the reagent, such as a nucleic acid array or a specific ligand array. The substrate may be a solid or semi-solid substrate such as any suitable support comprising glass, plastic, nylon, paper, metal, polymers and the like. The substrate may be of various forms and sizes, such as a slide, a membrane, a bead, a column, a gel, etc. The contacting may be made under any condition suitable for a detectable complex, such as a nucleic acid hybrid or an antibody-antigen complex, to be formed between the reagent and the nucleic acids or polypeptides of the sample.

In a preferred embodiment, the expression level may be determined by determining the quantity of mRNA.

Methods for determining the quantity of mRNA are well known in the art. For example the nucleic acid contained in the samples (e.g., cell or tissue prepared from the patient) is first extracted according to standard methods, for example using lytic enzymes or chemical solutions or extracted by nucleic-acid-binding resins following the manufacturer's instructions. The extracted mRNA is then detected by hybridization (e.g., Northern blot analysis) and/or amplification (e.g., RT-PCR). Preferably quantitative or semi-quantitative RT-PCR is preferred. Real-time quantitative or semi-quantitative RT-PCR is particularly advantageous. Other methods of amplification include ligase chain reaction (LCR), transcription-mediated amplification (TMA), strand displacement amplification (SDA) and nucleic acid sequence based amplification (NASBA).

Nucleic acids having at least 10 nucleotides and exhibiting sequence complementarity or homology to the mRNA of interest herein find utility as hybridization probes or amplification primers. It is understood that such nucleic acids need not be identical, but are typically at least about 80% identical to the homologous region of comparable size, more preferably 85% identical and even more preferably 90-95% identical. In certain embodiments, it is advantageous to use nucleic acids in combination with appropriate means, such as a detectable label, for detecting hybridization. A wide variety of appropriate indicators are known in the art including, fluorescent, radioactive, enzymatic, or other ligands (e.g. avidin/biotin).

Probes typically comprise single-stranded nucleic acids of between 10 to 1000 nucleotides in length, for instance of between 10 and 800, more preferably of between 15 and 700, typically of between 20 and 500. Primers typically are shorter single-stranded nucleic acids, of between 10 to 25 nucleotides in length, designed to perfectly or almost perfectly match a nucleic acid of interest, to be amplified. The probes and primers are “specific” to the nucleic acids they hybridize to, i.e. they preferably hybridize under high stringency hybridization conditions (corresponding to the highest melting temperature Tm, e.g., 50% formamide, 5× or ex SCC. SCC is a 0.15 M NaCl, 0.015 M Na-citrate). The nucleic acid primers or probes used in the above amplification and detection method may be assembled as a kit. Such a kit includes consensus primers and molecular probes. A preferred kit also includes the components necessary to determine if amplification has occurred. The kit may also include, for example, PCR buffers and enzymes; positive control sequences, reaction control primers; and instructions for amplifying and detecting the specific sequences.

In a particular embodiment, the methods of the invention comprise the steps of providing total RNAs extracted from cumulus cells and subjecting the RNAs to amplification and hybridization to specific probes, more particularly by means of a quantitative or semi quantitative RT-PCR.

In another preferred embodiment, the expression level is determined by DNA chip analysis. Such DNA chip or nucleic acid microarray consists of different nucleic acid probes that are chemically attached to a substrate, which can be a microchip, a glass slide or a micro sphere-sized bead. A microchip may be constituted of polymers, plastics, resins, polysaccharides, silica or silica-based materials, carbon, metals, inorganic glasses, or nitrocellulose. Probes comprise nucleic acids such as cDNAs or oligonucleotides that may be about 10 to about 60 base pairs. To determine the expression level, a sample from a test subject, optionally first subjected to a reverse transcription, is labeled and contacted with the microarray in hybridization conditions, leading to the formation of complexes between target nucleic acids that are complementary to probe sequences attached to the microarray surface. The labeled hybridized complexes are then detected and can be quantified or semi-quantified. Labeling may be achieved by various methods, e.g. by using radioactive or fluorescent labeling. Many variants of the microarray hybridization technology are available to the man skilled in the art (see e.g. the review by Hoheisel, Nature Reviews, Genetics, 2006, 7:200-210)

In this context, the invention further provides a DNA chip comprising a solid support which carries nucleic acids that are specific to at least one of the 227 genes in Table 4 or the 14 genes selected from the group consisting of ABCA6, DDIT4, DUSP1, GPR137B, IDUA, KCTD5, KRAS, NCAM1, NDNL2, OLFML3, PTPRA, SDF4, SLC26A3, and TERF2IP.

Other methods for determining the expression level of said genes include the determination of the quantity of proteins encoded by said genes.

Such methods comprise contacting the sample with a binding partner capable of selectively interacting with a marker protein present in the sample. The binding partner is generally an antibody that may be polyclonal or monoclonal, preferably monoclonal.

The presence of the protein can be detected using standard electrophoretic and immunodiagnostic techniques, including immunoassays such as competition, direct reaction, or sandwich type assays. Such assays include, but are not limited to, Western blots; agglutination tests; enzyme-labeled and mediated immunoassays, such as ELISAs; biotin/avidin type assays; radioimmunoassays; immunoelectrophoresis; immunoprecipitation, etc. The reactions generally include revealing labels such as fluorescent, chemiluminescent, radioactive, enzymatic labels or dye molecules, or other methods for detecting the formation of a complex between the antigen and the antibody or antibodies reacted therewith.

The aforementioned assays generally involve separation of unbound protein in a liquid phase from a solid phase support to which antigen-antibody complexes are bound. Solid supports which can be used in the practice of the invention include substrates such as nitrocellulose (e.g., in membrane or microtitre well form); polyvinylchloride (e.g., sheets or microtitre wells); polystyrene latex (e.g., beads or microtitre plates); polyvinylidine fluoride; diazotized paper; nylon membranes; activated beads, magnetically responsive beads, and the like. More particularly, an ELISA method can be used, wherein the wells of a microtiter plate are coated with an antibody against the protein to be tested. A biological sample containing or suspected of containing the marker protein is then added to the coated wells. After a period of incubation sufficient to allow the formation of antibody-antigen complexes, the plate (s) can be washed to remove unbound moieties and a detectably labeled secondary binding molecule added. The secondary binding molecule is allowed to react with any captured sample marker protein, the plate washed and the presence of the secondary binding molecule detected using methods well known in the art.

Alternatively an immunohistochemistry (IHC) method may be preferred. IHC specifically provides a method of detecting targets in a sample or tissue specimen in situ. The overall cellular integrity of the sample is maintained in IHC, thus allowing detection of both the presence and location of the targets of interest. Typically a sample is fixed with formalin, embedded in paraffin and cut into sections for staining and subsequent inspection by light microscopy. Current methods of IHC use either direct labeling or secondary antibody-based or hapten-based labeling. Examples of known IHC systems include, for example, EnVision™ (DakoCytomation), Powervision® (Immunovision, Springdale, Ariz.), the NBA™ kit (Zymed Laboratories Inc., South San Francisco, Calif.), HistoFine® (Nichirei Corp, Tokyo, Japan).

In particular embodiment, a tissue section (e.g. a sample comprising cumulus cells) may be mounted on a slide or other support after incubation with antibodies directed against the proteins encoded by the genes of interest. Then, microscopic inspections in the sample mounted on a suitable solid support may be performed. For the production of photomicrographs, sections comprising samples may be mounted on a glass slide or other planar support, to highlight by selective staining the presence of the proteins of interest.

Therefore IHC samples may include, for instance: (a) preparations comprising cumulus cells (b) fixed and embedded said cells and (c) detecting the proteins of interest in said cells samples. In some embodiments, an IHC staining procedure may comprise steps such as: cutting and trimming tissue, fixation, dehydration, paraffin infiltration, cutting in thin sections, mounting onto glass slides, baking, deparaffination, rehydration, antigen retrieval, blocking steps, applying primary antibodies, washing, applying secondary antibodies (optionally coupled to a suitable detectable label), washing, counter staining, and microscopic examination.

The invention also relates to a kit for performing the methods as above described, wherein said kit comprises means for measuring the expression level the levels of at least one of the 227 genes in Table 4 or the 14 genes selected from the group consisting of ABCA6, DDIT4, DUSP1, GPR137B, IDUA, KCTD5, KRAS, NCAM1, NDNL2, OLFML3, PTPRA, SDF4, SLC26A3, and TERF2IP that are indicative whether the oocyte or the embryo is competent.

The invention is further illustrated by the following description of how the inventors determined that the expression of the 227 genes in Table 4 and the 14 gene set on a cumulus cell correlates to oocyte competency and embryo development upon implantation and working examples. However, these examples and description should not be interpreted in any way as limiting the scope of the present invention.

An exemplary means by which this was effected is described in detail as follows.

The first aspect of reducing the invention to practice involved identifying genes which constitute the pregnancy signature in women and potentially other mammals and was achieved by identifying and comparing the expression of genes in cumulus cells collected from women donors which are pregnancy competent or not. This was effected by collecting cumulus cells from different human oocytes of donor women and implanting patients with one or two putatively fertilized eggs. These patients were then, based on the results of the implantation, divided into three groups based on full, partial, and no pregnancy. For each oocyte used in the process, the transcriptional profile of at least one cumulus cell surrounding the particular oocyte was determined using Affymetrix HG 133 Plus 2 arrays containing over 54,000 transcripts. Patients were included in the study only if they did not meet any of the exclusion criteria identified in Table 1.

TABLE 1
Patient Exclusion Criteria
On Female Side:
>35 years of age
Low Ovarian Reserve
PCOS
>IVF cycle 2
Presence of >4 cm fibroids
BMI >35
History of chemotherapy of
radiation to abdomen or pelvis
On Male Side:
History of testicular biopsy
<5 million sperm

More particularly, in order to find gene signatures predictive of an oocyte's ability to produce a healthy baby, the inventors profiled the transcriptome of cumulus cells surrounding the oocyte using Affymetrix HG 133 Plus 2 arrays containing over 54,000 transcripts. Total RNA from individual cumulus samples was isolated using the PicoPure RNA isolation kit (Molecular Devices, Sunnyvale, Calif.). Sample RNA was amplified using a protocol developed in-house which ensures faithful and consistent amplification of small amounts of RNA to levels required for microarray analysis (Kocabas, et al., Proc Natl Acad Sci USA, 103, 14027-14032 (2006)).

Resulting amplified RNA (aRNA) was hybridized to the Affymetrix arrays. Thirty-six samples were used for which none of the embryo transfers led to successful pregnancies (labeled N for No success) and 30 samples for which all of the transfers led to successful pregnancies (labeled F for Full success). There were no known confounding factors to effect pregnancy success and relevant clinical parameters such as age or IVF cycle number did not vary significantly between the F and N groups.

Quality Control (QC) parameters were calculated for all 65 samples using Expression Console™ (EC) software freely available by the manufacturer (Affymetrix). All QC parameters including scaling factor (coefficient needed to equate the 2% trimmed mean of overall chip intensity), percentage of probe sets called present, 3′-5′ ratios for spike and labeling controls and housekeeping genes were within acceptable ranges (as described in manufacturer's guidelines) for all the samples. There were no known confounding factors to affect pregnancy success and relevant clinical parameters such as oocyte age or IVF cycle number did not vary significantly (t-test p>0.05) between F and N groups (see Table 1). Additional criteria for acceptance included absence of Polycystic Ovarian Syndrome (PCOS), no history of chemotherapy or radiation to the abdomen or pelvis, absence of >4 cm intramural or submucosal fibroids, and on the male side, no history of testicular biopsy and sperm count of >5 million

In order to prove the soundness of the prediction model, F and N samples were divided randomly into training and validation sets. The goal was to find a predictive set of genes developed on the training set and then test the performance of the predictive genes on the validation set, which has not been used in development of the predictive model. This strategy (as opposed to using all the samples to develop a signature) prevents over-fitting and provides an assessment of predictive signature's robustness (Nevins, J. R. and Potti, A. (2007) Mining gene expression profiles: expression signatures as cancer phenotypes, Nat Rev Genet, 8, 601-609.)

As shown in Table 2, 33 samples (15F; 18N) were used in the training set and 32 samples (15F; 18N) in the validation set.

Samples used in training and validation sets are shown in Table 2.

TABLE 2
Samples used in the training and validation
sets for prediction purposes.

| Training | | Validation | |
|---|---|---|---|
| Sample | | Sample | |
| Name | Success | Name | Success |
| 8_100908 | F | 1B_100908 | F |
| 4B_100908 | F | 5B_100908 | F |
| 6_092308 | F | 1_092308 | F |
| 6A_101408 | F | 3B_101408 | F |
| 1A_100908 | F | 12_100908 | F |
| 15_100908 | F | 4_100908 | F |
| 6_101408 | F | 37_100908 | F |
| 1A_101408 | F | 8_092308CHP | F |
| 9_092308 | F | 4_072407 | F |
| 6A_100908 | F | 1b_032306 | F |
| 1_072407 | F | 2a_013007 | F |
| 5a_013007 | F | 2a_030206 | F |
| 3a_013007 | F | 4a_030206 | F |
| 3b_091406 | F | 2a_062807 | F |
| 6_072407 | F | 9_072407 | F |
| 1C_101408 | N | 5C_101408 | N |
| 4A_100908 | N | 2A_101408 | N |
| 10_100908 | N | 4C_100908 | N |
| 9_101408 | N | 9_100908 | N |
| 1a_092308 | N | 8_101408 | N |
| 4_101408 | N | 5B_101408 | N |
| 6_100908 | N | 11_101408 | N |
| 5_101408 | N | 3A_101408 | N |
| 9A_101408 | N | 6b_092308 | N |
| 1b_092308 | N | 7b_092308 | N |
| 5b_092308 | N | 7_100908 | N |
| 5C_100908 | N | 6_062906 | N |
| 10_062906 | N | 5a_030206 | N |
| 1a_030206 | N | CQ1 | N |
| CQ2 | N | PE1 | N |
| PE5 | N | PM2 | N |
| PM1 | N | X4 | N |
| X6 | N | | |

In FIG. 1, the inventors separately show the clustering of all F and N samples (65 samples), training set samples (33 samples), and validation set samples (32 samples) using all genes. Samples are clustered with hierarchical clustering utilizing average linkage method using Pearson's correlation as the metric of similarity following row normalization Sneath, P. (1973) Numerical taxonomy; the principles and practice of numerical classification. W.H. Freeman, San Francisco, Calif. USA.

During the clustering process complete transcriptional profiling on the chips, i.e. all 54K+ transcripts are used. The clustering of all three data sets indicates a lack of separation based on pregnancy success. This in turn suggests the need for supervised learning analysis to find phenotype specific gene identification to correlate the expression results with success and to eventually identify a predictive gene set.

In order to find genes that correlate with success, genes that show differential expression based on t-test (p<0.05 with Bonferroni correction for multiple hypothesis testing) were identified in the training set (F vs. N). Resulting 1180 genes, called “descriptive genes”, were used to cluster Training and Validation sets separately (FIG. 2). The results show successful separation of N and F samples, especially in the training set as samples in this set have been used to identify the pregnancy signature genes in Table 4 and the 14 genes selected from the group consisting of ABCA6, DDIT4, DUSP1, GPR137B, IDUA, KCTD5, KRAS, NCAM1, NDNL2, OLFML3, PTPRA, SDF4, SLC26A3, and TERF2IP.

Next, using these 1180 genes, leave-one-out-cross-validation (L1OXV) was performed in the training set. In this method, first number of genes in the predictive gene set, say P, is fixed. Then one sample in the training set is left-out and top P genes using the remaining samples that differentiate between N and F are calculated. Using these P genes, the sample that is left out is predicted as N or F. This process is cycled through all 33 samples in the training set (leaving one out at a time). The total number of correct predictions is listed as the accuracy of the predictor on the training set.

During L1OXV process, different values for P, number of predictor genes, are tried and for ones that show good L1OXV prediction accuracy, these genes are applied on the validation set. The number of samples correctly predicted in the validation set is reported as prediction accuracy in the validation set. The smallest P that yields high training and validation accuracies, i.e. P for which accuracy graph reaches a plateau, are reported as the predictor gene set. Prediction algorithms employed were Weighted Voting (Golub et al., Molecular classification of cancer: class discovery and class prediction by gene expression monitoring, Science, 286, 531-537 (1999), Bayesian Compound Covariate); Wright et 1., Proc Natl Acad Sci USA, 100, 9991-9996 (1999)); Diagonal Linear Discriminant, Dudoit et al., citation, 97, 77-87); Nearest Centroid, k-Nearest Neighbors (Golub et al., Molecular classification of cancer: class discovery and class prediction by gene expression monitoring, Science, 286, 531-537 (1999)); Shrunken Centroids, (Tibshirani et al., Proc Natl Acad Sci USA, 99, 6567-6572 (2002)); Support Vector Machines (Radmacher, et al., J Comput Biol, 9, 505-511 (2002)) and Compound Covariate (Hedenfalk et al., N Engl J Med, 344, 539-548 (2001)).

In our analysis the weighted voting approach performed the best prediction with a 227 gene predictor set yielding 97% L1OXV accuracy (32/33 correct predictions) and 88% (28/32 correct predictions) validation set accuracy. These 227 genes, called “predictive genes” yielded significant (p<0.05) prediction results on both training and validation sets using Fisher's tests. Prediction results are shown in Table 3.

TABLE 3
Prediction results for training and validation data sets.

| Training | | | Validation | | |
|---|---|---|---|---|---|
| | True | Predicted | | True | Predicted |
| Sample Name | Class | Class | Sample Name | Class | Class |
| 1b_092308 | N | N | 6b_092308 | N | N |
| 5b_092308 | N | N | 7b_092308 | N | N |
| 1a_092308 | N | N | 9_100908 | N | N |
| 6_100908 | N | N | 4C_100908 | N | N |
| 4A_100908 | N | N | 7_100908 | N | N |
| 10_100908 | N | N | 11_101408 | N | N |
| 5C_100908 | N | N | 8_101408 | N | N |
| 5_101408 | N | N | 3A_101408 | N | N |
| 9_101408 | N | N | 5B_101408 | N | N |
| 9A_101408 | N | N | 2A_101408 | N | N |
| 4_101408 | N | N | 5C_101408 | N | N |
| 1C_101408 | N | N | 5a_030206 | N | N |
| 1a_030206 | N | N | 6_062906 | N | N |
| 10_062906 | N | F | CQ1 | N | N |
| CQ2 | N | N | PE1 | N | N |
| X6 | N | N | PM2 | N | N |
| PE5 | N | N | X4 | N | N |
| PM1 | N | N | 8_092308CHP | F | F |
| 9_092308 | F | F | 1_092308 | F | F |
| 6_092308 | F | F | 4_100908 | F | F |
| 15_100908 | F | F | 12_100908 | F | F |
| 1A_100908 | F | F | 37_100908 | F | F |
| 8_100908 | F | F | 1B_100908 | F | F |
| 4B_100908 | F | F | 5B_100908 | F | N |
| 6A_100908 | F | F | 3B_101408 | F | N |
| 1A_101408 | F | F | 1b_032306 | F | F |
| 6_101408 | F | F | 2a_013007 | F | F |
| 6A_101408 | F | F | 2a_030206 | F | N |
| 1_072407 | F | F | 2a_062807 | F | F |
| 3a_013007 | F | F | 4_072407 | F | F |
| 3b_091406 | F | F | 4a_030206 | F | N |
| 5a_013007 | F | F | 9_072407 | F | F |
| 6_072407 | F | F | | | |

In FIG. 3, we show clustering of training and validation sets using the 227 predictive gene list, Note that the only sample incorrectly predicted in the training set is misplaced in the clustering as well, however, the mixed behavior of F and N samples in validation set clustering emphasizes the contribution made by the weighted voting approach.

Based on the foregoing the inventors have identified a set of human genes (contained in Table 4) the expression of which may be assessed on cumulus cells and compared to the level of expression of said gene that correlates to that of a normal oocyte, i.e., one associated with an oocyte that is capable of giving rise to a viable pregnancy, in order to assess the pregnancy potential of an oocyte associated with said cumulus cell (or an oocyte from the same donor that was used to isolate the tested cumulus cell). Analysis of additional samples resulted in identification of a preferred set of 14 genes (contained in Table 12) the expression of which may be assessed on cumulus cells and compared to the level of expression of said gene that correlates to that of a normal oocyte, i.e., one associated with an oocyte that is capable of giving rise to a viable pregnancy, in order to assess the pregnancy potential of an oocyte associated with said cumulus cell (or an oocyte from the same donor that was used to isolate the tested cumulus cell).

While these lists of genes are clinically relevant, we anticipate that these lists of 227 and 14 predictor genes may be further refined, subject to functional analysis, and further validated in order to identify a more optimal pregnancy signature set of genes.

With respect thereto, the following techniques which may be used to refine this list of predictor genes contained in Table 4 and in the 14 gene set contained in Table 12 are described below.

The inventors will assign significance to these 227 or 14 predictor genes (PG's) using two strategies: i) we will permute class labels, identify optimum 227 gene predictors using the same method applied previously, and calculate their performance on the perturbed data set; i) we will test the performance of randomly chosen 227 gene predictors using the original data set. Performance comparison of PG'S against results obtained using aforementioned strategies are used to assess PG'S's significance. In order to refine PG'S, we will divide the complete data set into alternative training and validation sets and for each split calculate an optimum predictive gene set. These predictors are compared to each other and PG'S to obtain a final predictive gene set composed of genes consistently coming up as good predictors. This final set will then be evaluated for its significance and accuracy. Finally, we will further analyze this final predictor gene set for i) Gene Ontology (GO) functional classification to find significantly over-represented GO categories, ii) involvement in known biological pathways, gene networks, disease pathways, small molecule and drug target interactions, iii) promoter region analysis to identify common/distinct transcriptional regulatory elements and miRNA target analysis, and iv) their localization, secretion potential, and ligation properties. In what follows we explain in detail this overall workflow, which is summarized in FIG. 4.

We have previously applied the approaches defined here on finding predictive biomarkers in diabetes, myelodysplastic syndrome, chronic liver disease and various forms of cancer using both high throughput transcriptional profiling and proteomic data sets (See: Aivadoet al., Proc Natl Acad Sci USA, 104, 1307-1312 2007).; Jones et al., Clin Cancer Res, 11, 5730-5739 (2007); Jones, et al., J Urol, 179, 730-736 (2007); Out et al. Diabetes Care, 30, 638-643 (2007); Out et al., J Biol Chem, 282, 11197-11204 (2007).; Prall et al., Int J Hematol, 89, 173-187 (2009); Spentzos et al., J Clin Oncol, 23, 7911-7918 (2005). and Zinkin et al., Clin Cancer Res, 14, 470-477 (2008). In all these studies, the biomarkers were found to be statistically significantly predictive and were independently validated both experimentally and analytically on new data sets that have not been used to define the predictor set.

Prediction Algorithm

The “signal to noise ratio” (SNR) is used to assess predictor value of a gene g (Golub et al., Science, 286, 531-537 (1999).) Let μF(g) and μN(g) be the mean value of gene g in F (successful pregnancy) and N (failed pregnancy) sample groups, respectively. Similarly, let σF(g) and σN(g) be the standard deviation of gene g in F and N sample groups, respectively. We define SNR(g)=[μF(g)−μN(g)]/[σF(g)+σN(g)]. This metric defines a neighborhood in RM around ideal gene expression vectors for both groups where M=|F|+|N|, total number of samples in the data set. SNR punishes genes with an expression highly deviant in either group and provides a signed ranking method for a gene's membership. In this case large positive values indicate a good predictor for the F group and large negative values (in absolute value) indicate a good predictor for the N group. We also define the boundary between the correlation between idealized expression patterns and a given gene g as B(g)=[μF(g)+μN(g)]/2.

In this method we assess the predictor gene set of P genes G={g1, g2, . . . gP}, a group of F and N samples and a new sample S to be predicted. The vote of gi, 1≦i≦P, is defined as Vi=SNR(gi)[S(gi)−B(gi)], where S(gi) represents the signal value of gene gi in S. Vi represents how well S(gi) relates to the “behavior” of gi in F and N samples. If Vi is positive, we conclude that based on gi, S is predicted to be F and if Vi is negative gi predicts S as N. Cycling through all genes in the predictor set we obtain P votes and let VF be the sum of all positive votes and VN be the sum of all negative votes. If VF is greater than VN in absolute value, we predict sample S as F; otherwise we predict S as N. In our previous studies we have obtained a robust predictor gene set using a training set, which was tested on an independent validation set.

Significance of Predictor Gene Set

In order to obtain a robust predictor gene set, samples are randomly divided into training and validation sets. We have previously left out cross validation (L1OXV) using weighted voting to obtain the 227 predictor gene set. In this analysis method we let T and V be the number of F and N samples used in training and validation sets, respectively. In this context, we left one of the samples in the training group out and found P genes with the highest SNR value in T-1 F and N samples in the training set. Using these P genes, the sample that was left out is predicted either as F or N using the procedure described above. Number of correct predictions amount to L1OXV prediction accuracy on the training set and minimum P with highest prediction accuracy is carried on to be tested on the validation set. In our preliminary studies P was found to be 227 and our prediction accuracies were 97% and 88% on training and validation sets, respectively.

We also assess the statistical significance of these 227 predictive genes. In order to assess this, we employ a two step strategy. In the first phase, we randomly shuffle the class labels of the samples used in the training set, i.e., we call a random subset of F samples as N and similarly call a random subset of N samples as F. Using this perturbed data set, we calculate L1OXV accuracy of 227 genes with the weighted voting method on the training set. In this setting, we choose 227 genes that have the highest SNR values using the permuted class labels. Assume the class label permutation is performed B times and the L1OXV accuracy of lath permutation is A. We assess L1OXV accuracy significance of our original 227 gene predictor set as p=1/BΣI(Ab>97%), where I is an indicator function and assumes a value of 1 if Ab>97% and 0 otherwise. Similarly, we let A′b be the prediction accuracy of 227 genes obtained using both permutations on the validation set. We then assess the prediction accuracy significance of our 227 gene predictor set on the validation set as p=1/BΣ(A′b>88%).

In the second phase to assess significance, we retain the original class labels but pick random 227 gene sets and evaluate their L1OXV accuracy on the training set and prediction accuracy in the validation set. We perform this random selection B times and let Ab and A′b be the L1OXV accuracy on the training set and prediction accuracy in the validation set for the bth selection, respectively. Similarly, the significance for L1OXV accuracy is calculated as p=1/BΣI(Ab>97%), and the significance for the validation set prediction accuracy are calculated as p=1/BΣI(A′b>88%). In both phases B=1000.

Further Refinement of the Predictor Gene Set

In order to further refine the 227 gene predictor set we also employ different training and validation set splits and look for the overlap in the resulting gene sets. With an attempt to find well defined predictors, in the refinement process, we do not split our whole data set in half into training and validation sets; rather, we use 75% of the samples for the training set and 25% of the samples for the validation set. Furthermore, we adopt a ten-fold cross validation strategy instead of a L1OXV. In this case, when finding a predictor on the training set, we do not leave one sample out at a time; instead, we leave 10% of the total number of samples in the training set out at a time. At each iteration, a predictor set is calculated using the remaining 90% samples and the left out 10% samples is predicted with the predictor set. Total number of correct predictions is then used to calculate prediction accuracy.

For each data split, we evaluate the prediction accuracy on the validation set and the significance of the predictor gene set as described above. We then intersect the predictor gene sets found at each split with each other and with the original 227 gene predictor set to find genes that consistently come up as good predictors. To this end, we form a more refined predictor gene set and calculate its prediction accuracy and significance on the overall data set using cross validation.

Clustering and Functional Analysis

Clustering of samples and genes are performed using Unweighted Pair Group Method with Arithmetic-mean (UPGMA)(Sneath, P. H. A. (1973) Numerical taxonomy; the principles and practice of numerical classification. W. H. Freeman, San Francisco, Calif. USA.), a hierarchical clustering technique used to construct a similarity tree, and principal components analysis (PCA)(Otu, et al., J Biol Chem, 282, 11197-11204 (2007)). In hierarchical clustering, expression data matrix is row-normalized for each gene prior to the application of average linkage clustering and Pearson's correlation is used as the distance measure. In PCA, which projects multivariate data objects into a lower dimensional space while retaining as much of the original variance as possible, each sample is normalized to mean zero and standard deviation one.

Functional analysis is comprised of finding Gene Ontology (GO) categories in the gene lists of interest that warrant further investigation (Ashburner, et al. Nat Genet, 25, 25-29 (2000)). Expression Analysis Systematic Explorer (EASE) identifies biologically-relevant categories that are over-represented in the set and therefore may be of further interest (Hosack et al., Genome Biol, 4, R70) (2003).

To accomplish this, EASE maps each probe to an Entrez Gene identifier (Maglott, et al., Nucleic Acids Res, 35, D26-31 (2001)) that is associated with a GO category. GO Consortium (Geneontology.org) assigns each gene (where applicable) to one or more classes in the three GO categories: biological function, cellular process, and molecular function. EASE identifies GO categories in the input gene list that are over-represented using jackknife iterative resampling of Fisher exact probabilities, with Bonferroni multiple testing correction. The “EASE score” is the upper bound of the distribution of Jackknife Fisher exact probabilities. Categories containing low numbers of genes are under-weighted so that the EASE score is more robust than the Fisher exact test. EASE analysis will test the predictor gene list against all genes on the chip, and an EASE score are calculated for likelihood of overrepresentation of a GO category in the input list. Overrepresentation describes a group of genes that belong to a certain GO category, e.g. cell cycle, that appear more often in the given input list than would be expected to occur if the distribution were random. The EASE score is a significance level with smaller EASE scores indicating increasing confidence in overrepresentation. We select GO categories that have EASE scores of 0.05 or lower as significantly over-represented.

Pathway Analysis

Pathway analysis, functional enrichment analysis or gene set analysis focuses on predefined gene sets or classes that are significantly regulated in a microarray study. We use Ingenuity Software Knowledge Base (IKB), (Redwood City, Calif.) to identify networks and pathways that best explain underlying transcriptional regulations. IKB uses interactions between genes and/or gene products based on manual curation of scientific literature providing a robust interaction database. Once a gene list of interest is analyzed the results are viewed in two ways: i) networks formed using input gene list and a limited expansion ii) known biological pathway that significantly host a subset of the input genes. Both results can further be analyzed in terms of drugs, small metabolites, functions, and diseases known to interact partly with the final gene networks. In this way, we identify pathways best explained by our predictive gene set and infer further perturbations to these networks. Furthermore, we are able to generate new interaction networks that do not necessarily fall in pre-defined canonical pathways.

Promoter and miRNA Target Analysis

We will interrogate 5 kb upstream of genes in our predictive signature and analyze these identified promoter regions using promoter analysis and interaction tool, PAINT (Vadigepalli et al., OMICS, 7, 235-252 (2003)) and oPOSSUM (Ho Sui et al., Nucleic Acids Res, 33, 3154-3164 (2005)). These methods model the promoter regions of input gene lists and identify transcription regulatory elements (TRE) in these regions. The results are then analyzed for over-representations of TREs and discover potential transcription factors that are important in gene regulation for the underlying microarray data.

Another potential mechanism of regulation of predictive genes is via miRNAs that regulate gene expression primarily through post-transcriptional repression or mRNA degradation in a sequence-specific manner. We can identify miRNA targets sites for predictive genes using TargetScanS (http://www.targetscan.org/). TargetScanS is an improved version of the Targetscan that searches the UTRs for segments of perfect Watson-Crick complementarities to base 2-8 of the miRNA, calculates a folding free energy G for each miRNA-target site interaction using RNAeval, and then assigns a Z score to each UTR (Lewis et al., Cell, 115, 787-798 (2003)). This way miRNA targets in the input gene list are identified through computation of miRNA binding sites.

Prediction of Secreted Proteins and Membrane Ligands

Localization and transport of proteins in the cell are governed by intrinsic signals in their amino acid sequences. We can analyze our predictive gene list in this context via the proteins they code for. In cases where annotation of a protein is sufficient to inform us about its localization, secretion potential, ligation and other properties, a manual filtering will suffice to isolate targets for further study. When substantial annotation is lacking, we are able to predict aforementioned properties of the protein using a highly accurate computational algorithm, TargetP, that uses neural networks and takes in consideration the characteristic of the N terminus of the proteins (Emanuelsson et al. Nat Protoc, 2, 953-971 (2007)). In case of secreted protein predictions, it helps to filter out ones that have transmembrane domains which would lessen the secretion potential of the protein. The transmembrane domain prediction on these proteins is performed using the standalone version of TMHMM, which uses a hidden Markov model for prediction (Sonnhammer et al., Proc Int Conf Intell Syst Mol Biol, 6, 175-182 (1998)). We also can supplement this analysis by the approach defined in PSORT9 Horton et al, Nucleic Acids Res, 35, W585-587 (2007)), which uses k-nearest neighbor classification and weighted matrices resulting from gapless multiple alignment in its prediction strategy.

Alternative Strategies

In addition we can optionally enhance our analysis in two ways:

Signal value calculation and normalization: Although model based methods such as dChip (Li et al., Genome Biol, 2, RESEARCH0032 (2001).) and RMA (Irizarry et al., Nucleic Acids Res, 31, e15. (2001)) may be used to normalize and summarize gene chip data and have been shown to be superior to Affymetrix MAS 5.0 normalization (Hubbell et al., Bioinformatics, 18, 1585-1592.(2002)), we have avoided using these methods as they depend on a baseline sample and do not adapt to addition of new samples (Barash et al., Bioinformatics, 20, 839-846 (2004)). In other words, as new samples are added to the data set, previous model based signal analysis becomes invalid and complete analysis workflow is therefore repeated. Because of our constantly growing data set and need to validate our previous findings in newly added samples, the inventors use MAS 5.0, a signal value calculation and normalization method that is robust to addition of new samples. A new method called Probe Logarithmic Intensity Error (PLIER) workflow in the Expression Console from Affymetrix (www.affymetrix.com) includes quintile normalization and produces improved signal values by utilizing the probes affinities, empirical probe performance and by handling the error appropriately across low and high concentrations (Katz et al., BMC Bioinformatics, 7, 464 (2006). Although PLIER is not as robust as MAS 5.0 to addition of new samples, it provides a better performance compared to model based methods and therefore are our alternative strategy for signal value calculation and normalization.

Prediction Algorithm:

In addition to weighted voting, which has been the best performing prediction algorithm in our previous studies, we plan to try the following prediction algorithms in case our results do not conform to the success criteria set forth in this application: Bayesian Compound Covariate (Dudoit et al. Journal of the American Statistical Association, 97, 77-87 (2002); Wright et al., Proc Natl Acad Sci USA, 100, 9991-9996 (2003)), Diagonal Linear Discriminant, Nearest Centroid, k-Nearest Neighbors(Golub et al., Science, 286, 531-537 (1999), Shrunken Centroids (Tibshirani et al., Proc Natl Acad Sci USA, 99, 6567-6572 (2002), Support Vector Machines (Radmacher et al., J Comput Biol, 9, 505-511 (2002)), and Compound Covariate (Hedenfalk et al., N Engl J Med, 344, 539-548 (2001)).

Validation of Predictive Gene Set Using qRT-PCR-Based Taqman™ Low Density Arrays (LDAs)

Taqman LDAs (Applied Biosystems) are microfluidic plates which allow for the simultaneous qRT-PCR analysis of 384 genes, from very small amounts of RNA, and with high fidelity. We use a single custom LDA to validate two sets of genes: 1.) the PG'S identified in the preliminary microarray study, and 2.) a set supplied by our collaborator, Dagan Wells, of Oxford University. In an independent study, Wells and colleagues identified a set of genes expressed in cumulus cells which are associated with aneuploidy in oocytes. Cytogenetic studies have revealed that, in women with an average age of 32, one quarter of oocytes are aneuploid (Fragouli Cytogenet Genome Res; 114:30-38 (2006). By combining both of these gene sets, a more optimal stronger pregnancy signature may be identified.

Based thereon we randomly select 25 F (Full pregnancy success) and 24 N (No pregnancy success) cumulus samples from the set of 65 that were previously subjected to microarray analysis for processing on our custom LDA. These cDNA (remaining from microarray analysis) are prepared and processed on an ABI 7900HT machine, one sample per LDA, according to Applied Biosystems' Taqman LDA instructions. Absolute quantification of each transcript is performed. Resultant amplification data are analyzed using 7000 System SDS Software (Applied Biosystems) and each gene intensity value are normalized to a control gene.

Comparison with Microarray Results

We apply Spearman's rank correlation and Mann-Whitney U test to compare expression levels for each gene across samples obtained via microarray and LDA. We will adopt these non-parametric and rank-based approaches as distributional assumptions in parametric models may not be valid in the two platforms and the signal values may not be comparable between the two platforms due to the difference in underlying technologies and normalization methods. We also calculate the degree of fold change between the F and N samples used on LDA for each of the genes tested. If the direction of this change is in accord with what we see in microarray results, gene's expression profile across the two platforms remain not-significantly changed (p>0.05) and highly correlated (r>0.9), we will label these genes as validated. We will assess validated genes' prediction power on samples used in LDA experiment using both LDA and microarray signal values separately. We also assess validated genes' prediction accuracy using the complete data set using microarray signal values. In these prediction processes we divide the samples into training and validation sets (75%-25% split) and calculate prediction accuracy by building a model on the training set and testing it on the validation set. In the prediction strategy we apply the weighted voting method as previously described.

Alternative Strategies

If the predictor genes are not validated as described above on the LDA platform or if a good prediction result is not obtained using validated genes, the prediction strategy can be modified to obtain higher accuracy and genes well correlated with pregnancy outcome by sacrificing the robustness of the predictive gene signature. For this purpose, we do not split the original data set into training and validation sets to calculate a predictive gene signature. Instead, we use the complete microarray data set to build a predictor, calculate its accuracy, and assess its statistical significance as previously described. During this prediction strategy we will use leave-ten-fold-out cross validation applied on the complete data set using weighted voting.

Application of Pregnancy Predictors in Other Samples

15 F (Full pregnancy success) and 15 N (No pregnancy success) new cumulus samples are collected. RNAs are isolated as described above. Reverse transcription are completed using ABI's High Capacity cDNA Reverse Transcription kit and cDNA amplification are completed using custom preamplification pools (ABI). Preamplification and qRT-PCR cycling will occur sequentially in an ABI 7900HT machine, one sample per LDA, according to Applied Biosystems' Taqman LDA instructions. Absolute quantification of each transcript is performed. Resultant amplification data are analyzed using 7000 System SDS Software (Applied Biosystems) and each gene intensity value are normalized to a control gene.

Using the final predictor genes that have been validated on the LDA platform, we build a prediction model on the complete data set consisting of samples in the prospective study. We then apply this model on the new samples using the signal values obtained in the retrospective study. In the prediction strategy we apply weighted voting method as previously described.

Alternative Strategies

Optionally, we may repeat our experiments performed in the retrospective study in order to get a more precise signal value, or increase the number of samples used in order to potentially enhance the statistical power of our validation efforts.

Therefore, based on the foregoing, in preferred embodiments the inventive methods are used to identify women subjects who produce or do not produce pregnancy competent oocytes based on the levels of expression of a set of differentially expressed genes contained in Table 4 or the set of 14 genes contained in Table 12 or the corresponding encoded polypeptides. However, the inventive methods are applicable to non-human animals as well, e.g., other mammals, including dogs, bats, bovines, horses, avians, amphibians, reptiles, et al. For example, the subject invention may be used to derive animal models for the study of putative female fertility treatments., i.e. by screening for compounds that modulate the expression of one or more of the pregnancy signature genes in Table 4 or the 14 gene set contained in Table 12 or a complement thereof. Additionally, the present invention may be used to identify female subjects who have an abnormality that precludes or inhibits their ability to produce pregnancy competent oocytes, e.g., ovarian dysfunction, ovarian cyst, pre-menopausal or menopausal condition, cancer, autoimmune disorder, hormonal dysfunction, cell proliferation disorder, or another health condition that inhibits or precludes the development of pregnancy competent oocytes.

For example, subjects who do not express specific pregnancy signature genes at characteristic expression levels are screened to assess whether they have an underlying health condition that precludes them from producing pregnancy competent oocytes. Particularly, such subjects are screened to assess whether they are exhibiting signs of menopause, whether they have a cancer, autoimmune disease or ovarian abnormality, e.g., ovarian cyst, or whether they have another health condition, e.g., hormonal disorder, allergic disorder, etc., that may preclude the development of “pregnancy competent” oocytes.

Additionally, the subject methods may be used to assess the efficacy of putative female fertility treatments in humans or non-human female subjects. Essentially, such methods will comprise treating a female subject, preferably a woman, with a putative fertility enhancing treatment, isolating at least one oocyte and associated surrounding cumulus cells from said woman after treatment, optionally further isolating at least one oocyte and associated surrounding cells prior to treatment, isolating at least one cumulus cell from each of said isolated oocytes; detecting the levels of expression of at least one gene that is expressed or not expressed at characteristic levels by cumulus cells that are associated with (surround) pregnancy competent oocytes; and assessing the efficacy of said putative fertility treatment based on whether it results in cumulus cells that express at least one pregnancy signature gene at levels more characteristic of cumulus cells that surround pregnancy competent oocytes (than without treatment). As noted, while female human subjects are preferred, the subject methods may be used to assess the efficacy of putative fertility treatments in non-human female animals, e.g., female non-human primates or other suitable animal models for the evaluation of putative human fertility treatments.

Still further, the present invention may be used to enhance the efficacy of in vitro or in vivo fertility treatments. Particularly, oocytes that are found to be “pregnancy incompetent”, or are immature, may be cultured in a medium containing one or more gene products that are encoded by genes identified as being “pregnancy signature” genes, e.g., hormones, growth factors, differentiation factors, and the like, prior to, during, or after in vivo, or in vitro fertilization. Essentially, the presence of these gene products should supplement for a deficiency in nutritional gene products that are ordinarily expressed by cumulus cells that surround “pregnancy competent” oocytes, and which normally nurture oocytes and thereby facilitate the capability of these oocytes to yield viable pregnancies upon fertilization.

Alternatively, one or more gene products encoded by said pregnancy signature genes or compounds that modulate the expression of such genes may be administered to a subject who is discovered not to produce pregnancy competent oocytes according to the methods of the invention. Such administration may be parenteral, e.g., by intravenous, intramuscular, subcutaneous injection or by oral or transdermal administration. Alternatively, these gene products may be administered locally to a target site, e.g., a female ovarian or uterine environment. For example, a female subject may have her uterus or ovary implanted with a drug delivery device that provides for the sustained delivery of one or more gene products encoded by “pregnancy signature” genes. or modulators of such genes.

Thus, in general, the present invention involves the identification and characterization, in terms of gene identity and relative abundance, of genes that are expressed by, cumulus cells derived from an egg, preferably human egg, at the time of ovulation, preferably cumulus cells, the expression levels of which correlate to the capability of said egg to give rise to a viable pregnancy upon natural or artificial fertilization and transferral to a suitable uterine environment.

In one exemplary embodiment, of the invention assays the expression of any combination, i.e., at least 1, 2, 3, 4, 5, 6, 10, 50, . . . 100 . . . 200 . . . 227 of the genes in Table 4 or any combination of the 14 genes in Table 12 by cumulus cells relative to levels expressed by normal cumulus cells using known nucleic acid or protein detection testing methods as exemplified above as a means of assessing oocyte competency or whether an individual produces competent oocytes.

However, while the invention in an exemplary embodiment will select any combination of the genes in Table 4 and Table 12 genes in a preferred embodiment the invention will assay the expression of at least 2 of the genes in Table 12, more preferably at least 3 and up to and including all 14 of these genes as a means of assessing oocyte competency. In addition the inventive methods alternatively may be practiced by monitoring the expression levels of one or more of the differentially expressed cumulus cell expressed genes selected from those in Table 4 and 12, the expression of which correlates to oocyte competency, in association with other genes, the expression of which is similarly found to be predictive.

TABLE 4
Human Genes Differentially Expressed By Human
Cumulus Cells Associated With Pregnancy Competency

| | | | | Fold |
|---|---|---|---|---|
| | | Representative | Entrez | Change |
| Gene Name | Gene Symbol | Public ID | Gene | (F/N) |
| claudin 1 | CLDN1 | AF101051 | 9076 | 5.413001 |
| CDNA FLJ20134 fis, | — | AK000141 | — | 1.622237 |
| clone COL06604 | | | | |
| CDNA FLJ31010 fis, | — | AK055572 | — | 1.616133 |
| clone HLUNG2000174 | | | | |
| calcium/calmodulin- | CAMK2N1 | AW162846 | 55450 | 1.555865 |
| dependent protein kinase II | | | | |
| inhibitor 1 | | | | |
| hypothetical protein | DKFZp547J222 | AL512720 | 84237 | 1.486741 |
| DKFZp547J222 | | | | |
| syntaxin 11 | STX11 | AF071504 | 8676 | 1.478423 |
| chromosome 1 open | C1orf180 | AK092806 | 439927 | 1.447737 |
| reading frame 180 | | | | |
| CDNA FLJ36648 fis, | — | R08650 | — | 1.446137 |
| clone UTERU1000138 | | | | |
| synuclein, beta | SNCB | NM_003085 | 6620 | 1.439097 |
| chromosome 15 open | C15orf41 | AK026504 | 84529 | 1.411212 |
| reading frame 41 | | | | |
| multiple EGF-like-domains | MEGF11 | AL834326 | 84465 | 1.404959 |
| 11 | | | | |
| DNA-damage-inducible | DDIT4 | NM_019058 | 54541 | 1.390497 |
| transcript 4 | | | | |
| transforming growth | TGFB2 | M19154 | 7042 | 1.390203 |
| factor, beta 2 | | | | |
| CD22 molecule | CD22 | X59350 | 933 | 1.366033 |
| Transcribed locus | — | AL080072 | — | 1.363304 |
| protein tyrosine | PTPRM | BC029442 | 5797 | 1.348507 |
| phosphatase, receptor type, M | | | | |
| — | — | NM_025062 | — | 1.336922 |
| hypothetical protein | LOC100128822 | AW952781 | 1E+08 | 1.330737 |
| LOC100128822 | | | | |
| DTW domain containing 1 | DTWD1 | AW977964 | 56986 | 1.307044 |
| dual specificity | DUSP1 | AA530892 | 1843 | 1.2986 |
| phosphatase 1 | | | | |
| tripartite motif-containing | TRIM10 | X90539 | 10107 | 1.295834 |
| 10 | | | | |
| G protein-coupled receptor | GPR137B | NM_003272 | 7107 | 1.287113 |
| 137B | | | | |
| reticulon 4 receptor-like 2 | RTN4RL2 | AI240883 | 349667 | 1.27649 |
| CDNA clone | — | BC009873 | — | 1.239883 |
| IMAGE: 3946787 | | | | |
| Glutamate receptor, | GRM5 | D60132 | 2915 | 1.234105 |
| metabotropic 5 | | | | |
| tripartite motif-containing 4 | TRIM4 | BE501464 | 89122 | 1.233475 |
| Transcribed locus | — | AW271932 | — | 1.233033 |
| Transcribed locus | — | AI808830 | — | 1.232386 |
| bromodomain and WD | BRWD1 | AI638279 | 54014 | 1.227435 |
| repeat domain containing 1 | | | | |
| Transcribed locus | — | AI821085 | — | 1.22535 |
| Transcribed locus | — | AI659426 | — | 1.225214 |
| RAD9 homolog B (S. cerevisiae) | RAD9B | NM_152442 | 144715 | 1.219942 |
| sialidase 2 (cytosolic | NEU2 | NM_005383 | 4759 | 1.218876 |
| sialidase) | | | | |
| necdin-like 2 | NDNL2 | AA627644 | 56160 | 1.21764 |
| CDNA FLJ11975 fis, | — | AK022037 | — | 1.214013 |
| clone HEMBB1001249 | | | | |
| fibroblast growth factor 12 | FGF12 | AL119322 | 2257 | 1.204025 |
| COBL-like 1 | COBLL1 | NM_014900 | 22837 | 1.194374 |
| Symplekin | SYMPK | Y10931 | 8189 | 1.193895 |
| Wilms tumor 1 associated | WTAP | NM_004906 | 9589 | 1.190418 |
| protein | | | | |
| Transcribed locus | — | AA251561 | — | 1.189774 |
| tenascin XB | TNXB | NM_019105 | 7148 | 1.188202 |
| angiopoietin-like 2 | ANGPTL2 | NM_012098 | 23452 | 1.185842 |
| CDNA FLJ36107 fis, | — | AW629387 | — | 1.183773 |
| clone TESTI2021819 | | | | |
| CDNA FLJ36457 fis, | — | H23431 | — | 1.183173 |
| clone THYMU2014500 | | | | |
| potassium channel | KCTD5 | AA872593 | 54442 | 1.179654 |
| tetramerisation domain | | | | |
| containing 5 | | | | |
| — | — | AV650953 | — | 1.175211 |
| Transcribed locus | — | AI732331 | — | 1.17038 |
| hypothetical protein | LOC339978 | BC043566 | 339978 | 1.168337 |
| LOC339978 | | | | |
| CTAGE family, member 5 | CTAGE5 | NM_005930 | 4253 | 1.164094 |
| Rap guanine nucleotide | RAPGEF1 | NM_005312 | 2889 | 1.160436 |
| exchange factor (GEF) 1 | | | | |
| Cholinergic receptor, | CHRNA3 | BC006114 | 1136 | 1.158333 |
| nicotinic, alpha 3 | | | | |
| MOCO sulphurase C- | MOSC2 | NM_017898 | 54996 | 1.156247 |
| terminal domain | | | | |
| containing 2 | | | | |
| keratin associated protein | KRTAP3-3 /// | AJ406933 | 100132276 | 1.155302 |
| 3-3 /// hypothetical protein | LOC100132276 | | /// | |
| LOC100132276 | | | 85293 | |
| transmembrane protein 9 | TMEM9 | AF151020 | 252839 | 1.151528 |
| KIAA0467 | KIAA0467 | AB007936 | 23334 | 1.140189 |
| activating transcription | ATF6 | NM_007348 | 22926 | 1.139882 |
| factor 6 | | | | |
| zinc finger protein 404 | ZNF404 | AA084273 | 342908 | 1.138368 |
| junctophilin 3 | JPH3 | AI680727 | 57338 | 1.138319 |
| coiled-coil and C2 domain | CC2D2A | BE893129 | 57545 | 1.136331 |
| containing 2A | | | | |
| olfactory receptor, family | OR1A2 | NM_012352 | 26189 | 1.131217 |
| 1, subfamily A, member 2 | | | | |
| family with sequence | FAM90A1 | NM_018088 | 55138 | 1.130777 |
| similarity 90, member A1 | | | | |
| chromosome 4 open | C4orf42 | AL390154 | 92070 | 1.129559 |
| reading frame 42 | | | | |
| Nucleoporin (GYLZ- | — | AY064415 | — | 1.127627 |
| RCC18) mRNA, GYLZ- | | | | |
| RCC18-NUP2 allele | | | | |
| hypothetical protein | LOC729178 | BC035182 | 729178 | 1.12651 |
| LOC729178 | | | | |
| Transcribed locus | — | AI288796 | — | 1.124611 |
| zinc finger protein 79 | ZNF79 | X65232 | 7633 | 1.124606 |
| Interleukin 1 family, | IL1F8 | NM_014438 | 27177 | 1.124428 |
| member 8 (eta) | | | | |
| KAT protein /// | hCG_20857 /// RP11- | AI814545 | 100131187 | 1.121303 |
| hypothetical protein | 544M22.4 | | /// | |
| LOC100134860 | | | 100134860 | |
| hypothetical protein | LOC285370 | AI357576 | 285370 | 1.120968 |
| LOC285370 | | | | |
| chromosome 1 open | C1orf74 | AW295407 | 148304 | 1.120949 |
| reading frame 74 | | | | |
| CD2 (cytoplasmic tail) | CD2BP2 | NM_006110 | 10421 | 1.120897 |
| binding protein 2 | | | | |
| heterogeneous nuclear | HNRNPR | BC001449 | 10236 | 1.112295 |
| ribonucleoprotein R | | | | |
| Na+/H+ exchanger domain | NHEDC2 | BF433180 | 133308 | 1.112154 |
| containing 2 | | | | |
| SH2 domain containing 4B | SH2D4B | AK091518 | 387694 | 1.109436 |
| solute carrier family 4, | SLC4A5 | AF453528 | 57835 | 1.109098 |
| sodium bicarbonate | | | | |
| cotransporter, member 5 | | | | |
| hairy and enhancer of split | HES7 | AB049064 | 84667 | 1.105084 |
| 7 (Drosophila) | | | | |
| Serine/threonine kinase 35 | STK35 | AW292935 | 140901 | 1.102551 |
| aristaless-like homeobox 4 | ALX4 | NM_021926 | 60529 | 1.102434 |
| nuclear receptor subfamily | NR2F6 | BF000629 | 2063 | 1.102388 |
| 2, group F, member 6 | | | | |
| telomeric repeat binding | TERF2IP | NM_018975 | 54386 | 1.102095 |
| factor 2, interacting protein | | | | |
| transmembrane protein | TMEM87A | BC005335 | 25963 | 1.097199 |
| 87A | | | | |
| dihydropyrimidine | DPYD | BC008379 | 1806 | 1.09698 |
| dehydrogenase | | | | |
| HEAT repeat containing 3 | HEATR3 | BC033077 | 55027 | 1.096173 |
| CDNA FLJ39333 fis, | — | AK025002 | — | 1.089562 |
| clone OCBBF2017306 | | | | |
| zinc finger protein 132 | ZNF132 | NM_003433 | 7691 | 1.088678 |
| potassium voltage-gated | KCNA6 | NM_002235 | 3742 | 1.08425 |
| channel, shaker-related | | | | |
| subfamily, member 6 | | | | |
| Meis homeobox 2 | MEIS2 | NM_020149 | 4212 | 1.080438 |
| calcium regulated heat | CARHSP1 | NM_014316 | 23589 | 1.077448 |
| stable protein 1, 24 kDa | | | | |
| sparc/osteonectin, cwcv | SPOCK2 | AI952009 | 9806 | 1.076532 |
| and kazal-like domains | | | | |
| proteoglycan (testican) 2 | | | | |
| hypothetical LOC642757 | FLJ32756 | BC041833 | 642757 | 1.075501 |
| solute carrier family 2 | SLC2A9 | NM_020041 | 56606 | 1.069368 |
| (facilitated glucose | | | | |
| transporter), member 9 | | | | |
| Chromosome 3 open | C3orf62 | BC032616 | 375341 | 1.067068 |
| reading frame 62 | | | | |
| fibroblast growth factor 12 | FGF12 | NM_004113 | 2257 | 1.066428 |
| zinc finger and BTB | ZBTB47 | AL133062 | 92999 | 1.065563 |
| domain containing 47 | | | | |
| CDNA clone | — | BC031274 | — | 1.065299 |
| IMAGE: 5294477 | | | | |
| chromosome 8 open | C8orf31 | NM_173687 | 286122 | 1.064842 |
| reading frame 31 | | | | |
| Chordin | CHRD | AF209929 | 8646 | 1.06252 |
| hypothetical protein | LOC284865 | AK092552 | 284865 | 1.060695 |
| LOC284865 | | | | |
| Immunoglobulin lambda | IGL@ | D87016 | 3535 | 1.057531 |
| joining 3 | | | | |
| CDNA FLJ13557 fis, | — | AU157438 | — | 1.056414 |
| clone PLACE1007737 | | | | |
| fibronectin type III and | FSD1L | AI970348 | 83856 | 1.0517 |
| SPRY domain containing | | | | |
| 1-like | | | | |
| signal-regulatory protein | SIRPD | AL049634 | 128646 | 1.046758 |
| delta | | | | |
| Transcribed locus | — | AI732305 | — | 1.043952 |
| Hemoglobin, epsilon 1 | HBE1 | AA115963 | 3046 | 1.043912 |
| — | — | AI969784 | — | 1.043734 |
| RUN domain containing | RUNDC3A | NM_006695 | 10900 | 1.036916 |
| 3A | | | | |
| Transcribed locus, strongly | — | BC015237 | — | 1.036842 |
| similar to NP_060631.2 | | | | |
| NAD synthetase 1 [Homo | | | | |
| sapiens] | | | | |
| zinc finger, SWIM-type | ZSWIM4 | AK024452 | 65249 | 1.032107 |
| containing 4 | | | | |
| killer cell | KIR2DL4 | NM_002255 | 3805 | 1.031994 |
| immunoglobulin-like | | | | |
| receptor, two domains, | | | | |
| long cytoplasmic tail, 4 | | | | |
| ATPase, | ATP8A1 | BC020943 | 10396 | 1.029996 |
| aminophospholipid | | | | |
| transporter (APLT), class I, | | | | |
| type 8A, member 1 | | | | |
| Chromosome 9 open | C9orf44 | BF591554 | 158314 | 1.028594 |
| reading frame 44 | | | | |
| arachidonate 15- | ALOX15B | AF468053 | 247 | 1.02354 |
| lipoxygenase, type B | | | | |
| rhomboid, veinlet-like 2 | RHBDL2 | NM_017821 | 54933 | 1.016638 |
| (Drosophila) | | | | |
| hypothetical LOC255031 | FLJ35390 | BC024303 | 255031 | 1.015271 |
| keratin 6A /// keratin 6B /// | KRT6A /// KRT6B /// | AL569511 | 286887 | 1.014761 |
| keratin 6C | KRT6C | | /// 3853 | |
| | | | /// 3854 | |
| hypothetical protein | MGC3196 | AI760124 | 79064 | 1.014488 |
| MGC3196 | | | | |
| family with sequence | FAM36A | AV694386 | 116228 | 1.0105 |
| similarity 36, member A | | | | |
| MRNA; cDNA | — | AL137596 | — | 1.005173 |
| DKFZp434A2111 (from | | | | |
| clone DKFZp434A2111) | | | | |
| dual specificity | DUSP12 | NM_007240 | 11266 | −1.00293 |
| phosphatase 12 | | | | |
| hypothetical gene | FLJ31945 | AI911996 | 440137 | −1.01104 |
| supported by AK056507 | | | | |
| CDNA FLJ36291 fis, | — | AK093610 | — | −1.01273 |
| clone THYMU2004003 | | | | |
| CDNA FLJ11818 fis, | — | AK021880 | — | −1.01378 |
| clone HEMBA1006424 | | | | |
| solute carrier family 26, | SLC26A3 | NM_000111 | 1811 | −1.01479 |
| member 3 | | | | |
| iduronidase, alpha-L- | IDUA | AI762782 | 3425 | −1.02249 |
| CDNA clone | — | BC016176 | — | −1.02256 |
| IMAGE: 3920493 | | | | |
| RIB43A domain with | RIBC1 | NM_144968 | 158787 | −1.02633 |
| coiled-coils 1 | | | | |
| DET1 and DDB1 | DDA1 | AB046843 | 79016 | −1.02796 |
| associated 1 | | | | |
| — | — | AW242763 | — | −1.02872 |
| ninein (GSK3B interacting | NIN | AF223937 | 51199 | −1.03046 |
| protein) | | | | |
| CDNA FLJ11662 fis, | — | AU145365 | — | −1.03369 |
| clone HEMBA1004629 | | | | |
| — | — | AL833072 | — | −1.03543 |
| Transcribed locus | — | AI760944 | — | −1.03574 |
| AT rich interactive domain | ARID1B | Y08266 | 57492 | −1.03865 |
| 1B (SWI1-like) | | | | |
| hypothetical protein | LOC100129792 | BF432331 | 1E+08 | −1.0404 |
| LOC100129792 | | | | |
| DiGeorge syndrome | DGCR6 /// DGCR6L | NM_005675 | 8214 /// | −1.04304 |
| critical region gene 6 /// | | | 85359 | |
| DiGeorge syndrome | | | | |
| critical region gene 6-like | | | | |
| Ubiquitin protein ligase | UBE3A | AF037219 | 7337 | −1.04342 |
| E3A (human papilloma | | | | |
| virus E6-associated | | | | |
| protein, Angelman | | | | |
| syndrome) | | | | |
| solute carrier family 12, | SLC12A5 | AF208159 | 57468 | −1.04431 |
| (potassium-chloride | | | | |
| transporter) member 5 | | | | |
| Membrane-associated ring | MARCH11 | AA383208 | 441061 | −1.05134 |
| finger (C3HC4) 11 | | | | |
| — | — | AW984341 | — | −1.05212 |
| hypothetical protein | LOC338579 | BC031237 | 338579 | −1.05648 |
| LOC338579 | | | | |
| Homo sapiens, clone | — | BC035649 | — | −1.05814 |
| IMAGE: 5575984, mRNA | | | | |
| pentatricopeptide repeat | PTCD1 | AB014532 | 26024 | −1.06376 |
| domain 1 | | | | |
| Full length insert cDNA | — | AF088044 | — | −1.06778 |
| clone ZD58F01 | | | | |
| hypothetical protein | LOC284352 | AC005757 | 284352 | −1.06893 |
| LOC284352 | | | | |
| — | — | AU150926 | — | −1.07019 |
| JTV1 gene | JTV1 | AF116615 | 7965 | −1.07128 |
| Hypothetical protein | LOC100132891 | AI948599 | 1E+08 | −1.07645 |
| LOC100132891 | | | | |
| cytochrome P450, family | CYP4F2 | D26480 | 8529 | −1.07856 |
| 4, subfamily F, polypeptide 2 | | | | |
| HCG1732469 | hCG_1732469 | NM_017624 | 729164 | −1.07929 |
| CDNA FLJ12204 fis, | — | AK022266 | — | −1.08062 |
| clone MAMMA1000921 | | | | |
| pro-melanin-concentrating | PMCH | NM_002674 | 5367 | −1.08286 |
| hormone | | | | |
| Transcribed locus | — | BE220224 | — | −1.08358 |
| dihydrofolate reductase | DHFR | AI144299 | 1719 | −1.0836 |
| CDNA FLJ35054 fis, | — | BF678148 | — | −1.08411 |
| clone OCBBF2018380 | | | | |
| Homo sapiens, clone | — | BC043545 | — | −1.0845 |
| IMAGE: 5171167, mRNA | | | | |
| CDNA clone | — | BC042007 | — | −1.08983 |
| IMAGE: 5311357 | | | | |
| — | — | BE327552 | — | −1.09536 |
| lipid storage droplet | LSDP5 | BC033570 | 440503 | −1.09813 |
| protein 5 | | | | |
| Transcribed locus | — | AI288679 | — | −1.09816 |
| Mucin | — | BF476613 | — | −1.09898 |
| — | — | AJ242956 | — | −1.10143 |
| pyrin and HIN domain | PYHIN1 | AI827431 | 149628 | −1.1053 |
| family, member 1 | | | | |
| similar to hCG2038397 | LOC100130264 | AK097497 | 1E+08 | −1.10606 |
| KIAA1305 | KIAA1305 | NM_025081 | 57523 | −1.10626 |
| Transcribed locus | — | AI668649 | — | −1.10773 |
| MRNA; cDNA | — | AL831948 | — | −1.10859 |
| DKFZp761B0218 (from | | | | |
| clone DKFZp761B0218) | | | | |
| P143 | — | AF334792 | — | −1.10946 |
| — | — | AK000293 | — | −1.11212 |
| Transcribed locus | — | BF432946 | — | −1.11417 |
| tubby homolog (mouse) | TUB | AK022297 | 7275 | −1.11822 |
| Transcribed locus | — | AI023133 | — | −1.12015 |
| ATP synthase, H+ | ATP5I | NM_007100 | 521 | −1.12194 |
| transporting, mitochondrial | | | | |
| F0 complex, subunit E | | | | |
| CDNA clone | — | BC015784 | — | −1.1287 |
| IMAGE: 4861280 | | | | |
| Transcribed locus, strongly | — | AI912965 | — | −1.13484 |
| similar to | | | | |
| XP_001102524.1 | | | | |
| PREDICTED: similar to | | | | |
| Olfactory receptor 2I1 | | | | |
| [Macaca mulatta] | | | | |
| Scaffold attachment factor B | SAFB | AI761858 | 6294 | −1.13835 |
| transmembrane protein | TMEM183A /// | AF070537 | 653659 | −1.14637 |
| 183A /// transmembrane | TMEM183B | | /// 92703 | |
| protein 183B | | | | |
| CDNA FLJ33813 fis, | — | AW376955 | — | −1.14739 |
| clone CTONG2002744 | | | | |
| Transcribed locus, weakly | — | AA861192 | — | −1.14786 |
| similar to XP_524364.2 | | | | |
| PREDICTED: zinc finger | | | | |
| protein 649 [Pan | | | | |
| troglodytes] | | | | |
| solute carrier family 6 | SLC6A1 | AI003579 | 6529 | −1.14947 |
| (neurotransmitter | | | | |
| transporter, GABA), | | | | |
| member 1 | | | | |
| tubulin tyrosine ligase | TTL | BG115434 | 150465 | −1.1509 |
| Transcribed locus | — | AW015319 | — | −1.15215 |
| — | — | AK026890 | — | −1.16401 |
| hypothetical protein | LOC338667 | BC043578 | 338667 | −1.16948 |
| LOC338667 | | | | |
| CDNA FLJ25946 fis, | — | AK098812 | — | −1.1715 |
| clone JTH14258 | | | | |
| Transcribed locus | — | BE889628 | — | −1.17156 |
| GLB2 gene, upstream | — | AF091526 | — | −1.17286 |
| regulatory region | | | | |
| FK506 binding protein 8, | FKBP8 | L37033 | 23770 | −1.17332 |
| 38 kDa | | | | |
| ST8 alpha-N-acetyl- | ST8SIA3 | NM_015879 | 51046 | −1.17723 |
| neuraminide alpha-2,8- | | | | |
| sialyltransferase 3 | | | | |
| chromosome 1 open | C1orf116 | NM_024115 | 79098 | −1.20692 |
| reading frame 116 | | | | |
| fatty acid binding protein | FABP7 | AL512688 | 2173 | −1.22273 |
| 7, brain | | | | |
| Transcribed locus | — | AI990286 | — | −1.22525 |
| suppressor of cytokine | SOCS1 | AA877218 | 8651 | −1.22717 |
| signaling 1 | | | | |
| CDC14 cell division cycle | CDC14B /// CDC14C | NM_152627 | 100131447 | −1.23322 |
| 14 homolog B (S. cerevisiae) | /// LOC100131447 | | /// | |
| /// CDC14 cell | | | 168448 | |
| division cycle 14 homolog | | | /// 8555 | |
| C (S. cerevisiae) /// | | | | |
| hypothetical | | | | |
| LOC100131447 | | | | |
| Transcribed locus | — | BE222041 | — | −1.23323 |
| RUN and SH3 domain | RUSC1 | NM_014328 | 23623 | −1.24197 |
| containing 1 | | | | |
| chromosome 16 open | C16orf72 | BG495327 | 29035 | −1.24528 |
| reading frame 72 | | | | |
| C-type lectin-like 1 | CLECL1 | BC042176 | 160365 | −1.26061 |
| arginase, type II | ARG2 | NM_001172 | 384 | −1.26369 |
| eyes absent homolog 3 | EYA3 | BC041667 | 2140 | −1.26724 |
| (Drosophila) | | | | |
| aquaporin 3 (Gill blood | AQP3 | N74607 | 360 | −1.27083 |
| group) | | | | |
| cDNA FLJ39819 fis, clone | — | BM676963 | — | −1.27232 |
| SPLEN2010534 | | | | |
| G protein-coupled receptor | GPR110 | AA746038 | 266977 | −1.27246 |
| 110 | | | | |
| inositol 1,4,5-trisphosphate | ITPKB | NM_002221 | 3707 | −1.27508 |
| 3-kinase B | | | | |
| similar to developmental | LOC341912 | AF111167 | 341912 | −1.27998 |
| pluripotency associated 5; | | | | |
| embryonal stem cell | | | | |
| specific gene 1 | | | | |
| calcium channel, voltage- | CACNA2D2 | NM_006030 | 9254 | −1.28016 |
| dependent, alpha 2/delta | | | | |
| subunit 2 | | | | |
| — | — | AF361491 | — | −1.28916 |
| CXXC finger 4 | CXXC4 | R41728 | 80319 | −1.29067 |
| hypothetical gene | LOC388692 | AA713827 | 388692 | −1.30283 |
| supported by AK123662 | | | | |
| — | — | AI191591 | — | −1.31547 |
| cDNA FLJ33029 fis, clone | — | AW954539 | — | −1.31899 |
| THYMU2000162 | | | | |
| Hypothetical gene | LOC387895 | AI138766 | 387895 | −1.32544 |
| supported by BC040060 | | | | |
| hypothetical protein | FLJ39743 | AK097062 | 283777 | −1.33788 |
| FLJ39743 | | | | |
| CCR4-NOT transcription | CNOT6L | NM_144571 | 246175 | −1.34995 |
| complex, subunit 6-like | | | | |
| coiled-coil domain | CCDC64B | AW139399 | 146439 | −1.35553 |
| containing 64B | | | | |
| nucleoporin 133 kDa | NUP133 | AU146738 | 55746 | −1.36092 |
| Transcribed locus | — | AL832727 | — | −1.37903 |
| pre-B-cell leukemia | PBX4 | AJ300182 | 80714 | −1.39029 |
| homeobox 4 | | | | |
| zinc finger protein 93 | ZNF93 | NM_031218 | 81931 | −1.39104 |
| unc-93 homolog A (C. elegans) | UNC93A | AL021331 | 54346 | −1.39988 |
| coronin, actin binding | CORO1B | AI341234 | 57175 | −1.40703 |
| protein, 1B | | | | |
| hypothetical protein | FLJ37396 | NM_173671 | 285754 | −1.45559 |
| FLJ37396 | | | | |
| chromosome 14 open | C14orf166B | AF111169 | 145497 | −1.45812 |
| reading frame 166B | | | | |
| hypothetical protein | LOC90113 | BC001200 | 90113 | −1.4584 |
| BC009862 | | | | |
| hypothetical protein | LOC284926 | BG828817 | 284926 | −1.49174 |
| LOC284926 | | | | |
| Transcribed locus | — | AI565624 | — | −1.56866 |
| leucine rich repeat | LRRC3B | AW027879 | 116135 | −1.61032 |
| containing 3B | | | | |
| hypothetical locus | FLJ22536 | H14782 | 401237 | −1.70566 |
| LOC401237 | | | | |

TABLE 5
HUMAN GENES USED TO VALIDATE DIFFERENTIAL
EXPRESSION DATA
Genes Used to Validate Differential
Expression Microarray Data Results

| Gene Symbol | TLDA Assay ID |
|---|---|
| CLDN1 | Hs01076359_m1 |
| PDE7B | Hs01054008_m1 |
| CAMK2N1 | Hs00218591_m1 |
| DKFZp547J222 | Hs00298862_s1 |
| C1orf180 | Hs03026345_u1 |
| SNCB | Hs00608185_m1 |
| C15orf41 | Hs01029993_m1 |
| MEGF11 | Hs00260981_m1 |
| DDIT4 | Hs01111686_g1 |
| TGFB2 | Hs00234244_m1 |
| MAG | Hs01114387_m1 |
| PTPRM | Hs00267809_m1 |
| DTWD1 | Hs00737889_m1 |
| DUSP1 | Hs00610257_g1 |
| TRIM10 | Hs00232497_m1 |
| GPR137B | Hs00162803_m1 |
| RTN4RL2 | Hs00604888_m1 |
| PPP1R15B | Hs00262481_m1 |
| GRM5 | Hs00168275_m1 |
| TRIM4 | Hs00263522_m1 |
| BRWD1 | Hs00219111_m1 |
| RAD9B | Hs00332650_m1 |
| NEU2 | Hs00193573_m1 |
| NDNL2 | Hs00328952_s1 |
| FGF12 | Hs00374427_m1 |
| COBLL1 | Hs00208564_m1 |
| SYMPK | Hs00191361_m1 |
| WTAP | Hs00374488_m1 |
| TNXB | Hs00372889_g1 |
| ANGPTL2 | Hs00765775_m1 |
| KCTD5 | Hs00368026_m1 |
| ATP8A1 | Hs00323527_m1 |
| RAPGEF1 | Hs00178409_m1 |
| CHRNA3 | Hs01095115_m1 |
| MOSC2 | Hs00215486_m1 |
| KRTAP3-3 | Hs00953462_s1 |
| TMEM9 | Hs00212825_m1 |
| KIAA0467 | Hs00390302_m1 |
| ATF6 | Hs00232586_m1 |
| JPH3 | Hs00221053_m1 |
| OR1A2 | Hs00360084_s1 |
| FAM90A1 | Hs00216400_m1 |
| C4orf42 | Hs00364580_s1 |
| LOC729178 | Hs01384704_m1 |
| ZNF79 | Hs00287927_m1 |
| IL1F8 | Hs00758166_m1 |
| F11R | Hs00375889_m1 |
| C1orf74 | Hs00331881_m1 |
| CD2BP2 | Hs00272036_m1 |
| HNRNPR | Hs00195167_m1 |
| NHEDC2 | Hs00604979_m1 |
| SH2D4B | Hs02575381_s1 |
| SLC4A5 | Hs01121579_m1 |
| HES7 | Hs00261517_m1 |
| STK35 | Hs00369871_m1 |
| ALX4 | Hs00222494_m1 |
| NR2F6 | Hs00172870_m1 |
| TERF2IP | Hs00430292_m1 |
| TMEM87A | Hs01064936_m1 |
| DPYD | Hs02510591_s1 |
| ARRDC1 | Hs00326522_m1 |
| ZNF132 | Hs01036387_m1 |
| KCNA6 | Hs00266903_s1 |
| CARHSP1 | Hs00183933_m1 |
| SPOCK2 | Hs00360339_m1 |
| TBC1D22A | Hs00378709_m1 |
| SLC2A9 | Hs00417125_m1 |
| C3orf62 | Hs00737144_m1 |
| ZBTB47 | Hs00378996_m1 |
| C8orf31 | Hs00543617_m1 |
| CHRD | Hs01000656_g1 |
| LOC284865 | Hs01376340_m1 |
| FSD1L | Hs00736434_m1 |
| SIRPD | Hs00988049_m1 |
| MTUS1 | Hs00826834_m1 |
| HBE1 | Hs00362216_m1 |
| EHD4 | Hs00248124_m1 |
| RUNDC3A | Hs00198594_m1 |
| ZSWIM4 | Hs00397653_m1 |
| KIR2DL4 | Hs00427106_m1 |
| ALOX15B | Hs00153988_m1 |
| RHBDL2 | Hs00384848_m1 |
| KRT6A | Hs01699178_g1 |
| FAM36A | Hs00831105_s1 |
| DUSP12 | Hs00170898_m1 |
| SLC26A3 | Hs00995363_m1 |
| IDUA | Hs00164940_m1 |
| RIBC1 | Hs00330280_m1 |
| DDA1 | Hs00610984_m1 |
| NIN | Hs00794913_m1 |
| FOXP1 | Hs00415004_m1 |
| ARID1B | Hs00368175_m1 |
| DGCR6 | Hs00606390_mH |
| UBE3A | Hs00166580_m1 |
| SLC12A5 | Hs01110928_m1 |
| PTCD1 | Hs00248918_m1 |
| MVK | Hs00176077_m1 |
| CYP4F2 | Hs00426608_m1 |
| PMCH | Hs00173595_m1 |
| CTTNBP2 | Hs00364312_m1 |
| DHFR | Hs00758822_s1 |
| LSDP5 | Hs00965990_m1 |
| PYHIN1 | Hs00378651_m1 |
| LOC100130264 | Hs01382384_m1 |
| KIAA1305 | Hs00830469_s1 |
| BARD1 | Hs00184427_m1 |
| PDSS2 | Hs00220614_m1 |
| TUB | Hs00163231_m1 |
| ATP5I | Hs00273015_m1 |
| SAFB | Hs00161495_m1 |
| TMEM183A | Hs02577166_g1 |
| SESN3 | Hs00376220_m1 |
| SLC6A1 | Hs01104469_m1 |
| TTL | Hs00542266_m1 |
| ERAP2 | Hs01073631_m1 |
| FKBP8 | Hs00273319_m1 |
| ST8SIA3 | Hs00288761_s1 |
| FABP7 | Hs00361426_m1 |
| SOCS1 | Hs00705164_s1 |
| TDP1 | Hs00217832_m1 |
| RUSC1 | Hs00204904_m1 |
| C16orf72 | Hs00415599_m1 |
| CLECL1 | Hs00416849_m1 |
| ARG2 | Hs00982837_m1 |
| EYA3 | Hs00157443_m1 |
| AQP3 | Hs00185020_m1 |
| GPR110 | Hs00228100_m1 |
| ITPKB | Hs00176666_m1 |
| CACNA2D2 | Hs01021049_m1 |
| CXXC4 | Hs00228693_m1 |
| DGKE | Hs00177537_m1 |
| FLJ39743 | Hs00753595_s1 |
| CNOT6L | Hs00375913_m1 |
| NUP133 | Hs00217272_m1 |
| FYB | Hs01061561_m1 |
| PBX4 | Hs00257935_m1 |
| ZNF93 | Hs01656246_s1 |
| UNC93A | Hs00219157_m1 |
| CORO1B | Hs00252726_m1 |
| C14orf166B | Hs00332462_m1 |
| LRRC3B | Hs00364791_m1 |
| PTPRA | Hs00160751_m1 |
| OLFML3 | Hs00220180_m1 |
| CXCL2 | Hs00601975_m1 |
| NCAM1 | Hs00941821_m1 |
| LSAMP | Hs00158884_m1 |
| HNF4A | Hs01023298_m1 |
| KANK2 | Hs00795260_m1 |
| ADAMTS2 | Hs00247980_m1 |
| CTNND1 | Hs00931670_m1 |
| FCHSD2 | Hs00207952_m1 |
| SDF4 | Hs00275083_m1 |
| EGFR | Hs01076086_m1 |
| THOC1 | Hs00192903_m1 |
| CRP | Hs00265044_m1 |
| IFT140 | Hs00206938_m1 |
| GPC6 | Hs00170677_m1 |
| TPM4 | Hs01861627_g1 |
| ABCA6 | Hs00365329_m1 |
| TAS1R2 | Hs01027711_m1 |
| CRIM1 | Hs00212750_m1 |
| RBM6 | Hs00172915_m1 |
| THBS1 | Hs00962914_m1 |
| CADM3 | Hs01003862_m1 |
| SOX4 | Hs00268388_s1 |
| CDR2L | Hs00412746_m1 |
| B3GNT7 | Hs01912656_s1 |
| DAAM1 | Hs00323674_m1 |
| RWDD2B | Hs00213555_m1 |
| SFRP4 | Hs00180066_m1 |
| CBX6 | Hs00204726_m1 |
| PTBP1 | Hs00243060_m1 |
| C6orf145 | Hs00406043_m1 |
| DNAJC15 | Hs00387763_m1 |
| RENBP | Hs00234138_m1 |
| C15orf43 | Hs00415148_m1 |
| KRAS | Hs00270666_m1 |
| BMPR1B | Hs00176144_m1 |
| STXBP2 | Hs00199557_m1 |
| DTNB | Hs00222463_m1 |
| MYOD1 | Hs00159528_m1 |
| ZAN | Hs00361830_m1 |
| NTS | Hs00175048_m1 |
| MAPK8IP2 | Hs00183753_m1 |
| LOC55908 | Hs00218820_m1 |
| PTPRS | Hs00161009_m1 |
| DGCR7 | Hs01561390_s1 |
| RUFY2 | Hs00396174_m1 |
| TK2 | Hs00936918_m1 |
| XYLT2 | Hs01048792_m1 |
| SLC35F2 | Hs00213850_m1 |
| PUM2 | Hs01093540_m1 |
| LPP | Hs00194400_m1 |
| IQWD1 | Hs00251184_m1 |
| DMRTB1 | Hs00380834_m1 |
| APCDD1L | Hs00542128_m1 |

As shown in Table 4 we identified 227 genes predictive of IVF success and 4128 differentially expressed genes. On the TLDA chips, we represented 199 of these genes, representing 196 unique ones (B3GNT7, ATP8A1, and DNAJC15 are represented by two probe sets). Out of these 196, 141 belong to the predictive set (represented by P in the “group” column of Excel files) and 55 belong to differentially expressed set (represented by A after “All” as all samples were used to find differentially expressed genes).

The output of TLDA experiments are threshold cycle (Ct) values, which are “the fractional cycle number at which the fluorescence passes the threshold”. These values are in logarithmic scale (base 2) and are inversely related to expression. For example, let Ct values for genes X and Y be 18 and 19, respectively. This means we “detect” X “well” at 18th cycle, which is, in comparison to Y (detected well at 19th cycle) renders two times greater expression level. Hence, to calculate classical fold change between X and Y (X/Y), we need to subtract X from Y and take that to power 2.

There are no spike-in controls to provide normalization across arrays. To do approximate normalization, Ct values of all genes are considered across samples and one with the most stable expression is chosen. Delta Ct (dCt) value for each gene in a plate (sample) is calculated by subtracting the Ct value of the “stable” gene (in that plate) from each gene's Ct value. Statminer analysis found the “stable” gene to be GAPDH.

Samples used on TLDA from our “old samples used in prediction analysis” are given in Table 6 below. In the Table the “h” corresponds to an incorrectly predicted sample in previous analysis.

TABLE 6
Samples from previous analysis used in TLDA experiments

| Sample Name | Group | Sample Name | Group |
|---|---|---|---|
| 10_062906* | N | 1_072407 | F |
| 1a_030206 | N | 1_092308 | F |
| 1a_092308 | N | 15_100908 | F |
| 1C_101408 | N | 1A_100908 | F |
| 3A_101408 | N | 1A_101408 | F |
| 4C_100908 | N | 1b_032306 | F |
| 5a_030206 | N | 2a_013007 | F |
| 5B_101408 | N | 3b_091406 | F |
| 5C_100908 | N | 6_072407 | F |
| 7_100908 | N | 6_092308 | F |
| 9_100908 | N | 6A_100908 | F |
| PE5 | N | 6A_101408 | F |
| PM1 | N | 8_100908 | F |
| PM2 | N | 9_072407 | F |
| X6 | N | 9_092308 | F |
| CQ2 | N | 5b-100908* | F |
| | | 2a-030206* | F |
| | | 4a-030206* | F |
| | | 3b-101408* | F |

Therefore, we have 19 F and 16 N samples for a total of 35. We also ran 14 new samples: 11 N 3 F, as shown in Table 7.

TABLE 7
New samples used in TLDA experiments.

| Sample Name | Group | Sample Name | Group |
|---|---|---|---|
| 42-082609-2 | N | 54-072909-9 | F |
| MAC#4 092308 | N | SMG#10 111609 | F |
| MAC#5 092308 | N | 17-100709-22 | F |
| BJP#9 111709 | N | | |
| JRC#1 111708 | N | | |
| CMA#3 090208 | N | | |
| JRC#2 111708 | N | | |
| AMP#2 021609 | N | | |
| BAS#1 030309 | N | | |
| CMA#2 090208 | N | | |
| MAC#6 092308 | N | | |

Data Quality

We checked distribution for the “detection” call of genes. If a gene's expression level is undetermined, it is assigned a value of 40. In FIG. 5, we show the number of samples with a value of 40 for each gene, separately plotted for our genes (196 genes labeled “Hasan genes”) and all 379 genes on TLDA (labeled “All genes”). In this Figure for each gene, number of samples wherein the gene has a value of 40 is shown. In the Figure the results are calculated for all samples.

In toto for our genes, we have 2237 values equal to 40 out of 6860 (196*35) values indicating that 32.6% of measurements yield undetected genes. In the inventive quantitative analyses it is permissible to have genes with a value of 40 as we expect some genes to be almost non-existent in some samples. By contrast, in our methods it is not permissible to have a gene undetected in all 35 samples. For example, for our genes, we have 62 genes for which there has been no detection for 30 or more samples. When all genes are considered, the percentage of measurements with a value of 40 is about 27.4%: 3631 out of 13230 (378*35).

In FIG. 6, we show number of genes called 40 for each sample. This in a way shows the detection level we get for each sample. In this figure we see some samples with suboptimal overall detection like 9_{—}072407, which has 117 of Hasan Genes and 212 of all genes with a value of 40. The average±st. dev. value of number of genes called 40 across samples is 63.9±14.5 for Hasan Genes and 103.7±28.6 for all genes.

In addition, we effected a similar analysis for 14 “new” samples. Therein we see 541 out of 2744 (14*196) values equal to 40 in Hasan Genes (corresponding to 19.7% of measurements) and 896 out of 5292 (14*378) values equal to 40 in All Genes (corresponding to 16.9% of measurements). These are more than 10% better than what we see in “old” samples. We show in FIGS. 7 and 8 a number of samples and number of genes with a value of 40 when data is analyzed with respect to genes and samples, respectively.

FIG. 7 shows for each gene, the number of samples for which the gene has a value of 40. Results are calculated for the tested 14 samples.

For our gene list, we have 25 genes that have 12 or more samples for which they have a value of 40. In FIG. 8 the number of genes with a value of 40 is shown for each sample and results are calculated for the 14 “new” samples.

Therein, we see one sample with bad overall detection: 17_{—}100709_{—}22, which has 85 of a human gene set that are differentially expressed on cumulus cells which we refer to as “Hasan Genes” and 140 of genes with a value of 40 in the old data set. The average±st. dev. value of number of genes called 40 across samples is 38.6±13.7 for Hasan Genes and 64.0±22.8 for all genes, in the new data set, which is improved relative to the prior data set.

These results suggest that TLDA detection for the new samples was an improvement relative to the old samples and some sort of filtering on the genes would be required. This filtering could be based on number of samples for which the gene has an expression value of 40, i.e. undetected. As discussed above, for example, for the prior samples, we have numerous genes where the gene is not detected in more than 85% of the samples, regardless of sample's group.

Data Analysis

There are various issues to consider such as handling of data points that have a value of 40, calculating fold change, and whether or not to use logged values. Below, we address such issues providing potential solutions.

Scaling: We have two sets of output: Ct values (logged expression levels) and dCt values, where for a given sample, each gene's dC value is calculated by subtracting GAPDH's Ct value from the gene's Ct value. Since Ct values are logarithmic, this corresponds to dividing each gene's expression value by GAPDH's expression value. In other words, it is the fold change between a gene and GAPDH. Moving on with these values mean calculating fold change between groups based on genes' fold change with respect to GAPDH. Since GAPDH is not one of the endogenous controls used on the array, there are no spike-in controls used in TLDA, and small variations in logarithmic scale may imply large differences in real values, we approach this with some caution. Nevertheless, we provide analysis both using scaled and unsealed values. For the remainder of this report unsealed values refer to Ct values as obtained in amplification files and scaled values refer to dCt values obtain by subtracting GAPDH.

Fold Change:

Assuming we have two samples A and B, and gene X's expression values in these samples are aX and bX, respectively. What we see in TLDA output (Ct values) are log(aX) and log(bX). If you want to calculate fold change between these two samples, you would subtract Ct values and take that to power of 2. That is, FC=2 log(aX)−log(bX). The reason for this is the following rules: log p−log q=log(p/q) and 2 log 2p=p. However, since Ct values are reversed, i.e. a smaller value means larger expression, this FC gives you the fold change B/A. To exemplify, if we see a Ct value of 10.8 in A and 12.3 in B, this means this gene is upregulated in A and fold change for B/A is 2 10.8−12.3=2−1.5=0.35. In other words, this gene is upregulated in A by 110.35=2.8 times. Another way to arrive this point is first to unlog Ct values and then calculate FC as we know it, except that the direction is reversed, i.e. in Ct world less means more. Hence, we have the expression level for A=2 10.8=1782, the expression level for B=2 12.3=5042, and FC B/A=1782/5042=0.35.

FC values less than 1 are hard to interpret so what we do is we reverse them and put a minus sign. For the above example, instead of saying FC for B/A is 0.35, we say FC for B/A is −1/0.35=−2.8. In all my calculations, we always subtracted F values from N values (if we were using log scale) or divided N values by F values (if we used unlogged values) and calculated FC for F/N. we used negative values to depict FCs less than 1 as explained above.

As if it has not been complicated enough to calculate a simple FC, we have more to think about. The example above contained only two samples, or, you can view it as having one sample in each group. How about if we have more than one sample in each group, as in our case (16 N, 19F)? If you average Ct values, you indeed get a geometric mean of expression levels. If you then subtract averages of Ct values in two groups and then take that to the power of two, this in turn means calculating FC by dividing geometric means of expressions in two groups. The reason for this is the following rules: alogX=logXa and logp+logq=log(pq).

To give an example, assume you have expression levels a, b, and c in group N and d, e, f, and g in group F. What we see in TLDA output is loga, logb, . . . , etc. In order to calculate FC (F/N), if we subtract the average value in F from the average value in N and then take that to power 2, we get the following:

Average in N=1/3[log a+log b+log e]=1/3 log [abc]=log (abc)1/3

Average in F=1/4[log d+log e+log f+log g]=1/4 log [defg]=log (defg)1/4

FC(F/N)=2̂[log (abc)1/3−log (defg)1/4]=2̂{log [(abc)1/3/(defg)1/4]}=(abc)1/3/(defg)1/4

Recall that geometric mean of n numbers is nth root of their products. Therefore, we always choose to work with unlogged values. That is, we first took Ct values to the power of 2 and then did my analyses.

40:40 is an arbitrary Ct value considered high enough to represent a gene that has not been detected. However, if you set it to 42 instead of 40, all your results will change. Therefore, we resolved this by first looking at all values that are not 40 and ranked them. For Hasan Genes, this corresponds to ranking 4623 values. We then looked at the bottom 2% of these genes, that is the lowest 92 genes; calculated their average and standard deviation, which turned out to be 37.9 and 0.8. We then replaced each 40 by a number randomly chosen between the interval [37.9−0.8, 37.9+0.8].

Outliers: When you manually look at the expression levels, you often see samples that behave as outliers for a given gene. In order to overcome this we removed the highest and lowest expression levels in a group (N or F) when calculating FC. We also repeated this procedure by removing highest two and lowest two samples in each group.

In conclusion, using the foregoing statistical methods we found that the level of expression of genes in Table 4 (which set of genes includes ABCA6, DDIT4, DUSP1, GPR173B, IDUA, KCTD5, NDNL2, SLC26A3 and TERF2IP as well as an additional 6 genes KRAS, NCAM1, OLFML3, PTPRA, and SDF4) by cumulus cells correlates to the capability of an oocyte associated therewith or from the same women donor to result in a viable pregnancy. Therefore, methods which detect the expression of one or more of these genes by a cumulus cell may be used in order to determine whether an oocyte associated therewith or from the same women donor is suitable for use in an IVF procedure.

To confirm these results we did a 14N vs. 17F comparison and a 12N and 15F comparison as described below.

Filtering Genes: There are some genes that are undetected in most of the samples. In the extreme, we have 20 genes designated “Hasan Genes” that are given a Ct value of 40 in all 35 samples. The use of these genes is not of predictive value. As a general approach, we eliminated genes that are undetected in 25 or more samples.

Results

Using the foregoing methods we have generated three data sets based on removal of outliers, where outlier is the sample(s) with highest or lowest expression in a group given a gene: i) we removed no samples (denoted by “remove none” in Excel file names) ii) we removed samples with highest and lowest expression value in each group (N and F), i.e. FC is calculated using 14N and 17F samples (denoted by “remove 1” in Excel file names) iii) we removed samples with top two highest and top two lowest expression values in each group (N and F), i.e. FC is calculated using 12N and 15F samples (denoted by “remove 2” in Excel file names).

For each data set, we handled 40s as explained above, i.e. we replaced them with random values between average of the lowest two percent of all detected values plus/minus standard deviation of those values. We then unlogged expression levels and generated two files for each data set: Scaled (for a given sample, each gene's expression level is divided by GAPDH's expression level in that sample) and Unsealed (no GAPDH or any other scaling is applied),

For each Excel file (totaling 6, 2 for each of 3 data sets), we also included columns “group”: P (gene is from the predictive signature) A (gene is from differential expression analysis using combined training and validation samples, i.e. all samples in microarray analysis; “count 40”: showing number of samples a gene assumes the value 40; “FC TLDA”: FC calculated as ratio of averages; “FC Affy”: FC coming from microarray analysis; “Agree”: showing if the direction of increase is the same in TLDA and Affy; we used 10 to indicate agreement and −10 otherwise.

In FIG. 9 we show the distribution of genes that are in agreement between TLDA and microarray. A tabulated form of these results is in Table 8, where we break down the level of agreement based on genes' up/down regulation from microarray results. Here, we use all genes, i.e. no filtering is applied based on the number of samples where the gene has been shown to be 40.

In Table 8 below we show the number of genes that show agreement in direction of upregulation between TLDA and microarray analysis in direction of upregulation between TLDA and microarray analysis. S: scaled, U: unsealed. P: predictive gene list. A: Genes obtained when all samples were analyzed together in microarray data set. T: Total genes. No genes were filtered out.

TABLE 8

| | | | Agree Up | Agree Down |
|---|---|---|---|---|
| Removed | GAPDH | Agree All | in F | in F |
| None | S | P: 73/141 | P: 39/78 (50%) | P: 34/63 (54%) |
| | | (52%) | | |
| | | A: 32/55 (58%) | A: 17/30 (57%) | A: 15/25 (60%) |
| | | T: 105/196 | T: 56/108 | T: 49/88 (56%) |
| | | (54%) | (52%) | |
| | U | P: 77/141 | P: 43/78 (55%) | P: 34/63 (54%) |
| | | (55%) | | |
| | | A: 23/55 (42%) | A: 13/30 (43%) | A: 10/25 (40%) |
| | | T: 100/196 | T: 56/108 | T: 44/88 (50%) |
| | | (51%) | (52%) | |
| One | S | P: 84/141 | P: 43/78 (55%) | P: 41/63 (65%) |
| | | (60%) | | |
| | | A: 36/55 (65%) | A: 19/30 (63%) | A: 17/25 (68%) |
| | | T: 120/196 | T: 62/108 | T: 58/88 (66%) |
| | | (61%) | (57%) | |
| | U | P: 77/141 | P: 60/78 (77%) | P: 17/63 (27%) |
| | | (55%) | | |
| | | A: 33/55 (60%) | A: 24/30 (80%) | A: 9/25 (36%) |
| | | T: 110/196 | T: 84/108 | T: 26/88 (30%) |
| | | (56%) | (78%) | |
| Two | S | P: 83/141 | P: 40/78 (51%) | P: 43/63 (68%) |
| | | (59%) | | |
| | | A: 37/55 (67%) | A: 18/30 (60%) | A: 19/25 (76%) |
| | | T: 120/196 | T: 58/108 | T: 62/88 (70%) |
| | | (61%) | (54%) | |
| | U | P: 78/141 | P: 61/78 (78%) | P: 17/63 (27%) |
| | | (55%) | | |
| | | A: 32/55 (58%) | A: 24/30 (80%) | A: 8/25 (32%) |
| | | T: 110/196 | T: 85/108 | T: 25/88 (28%) |
| | | (56%) | (79%) | |

These results suggest removing top one or two outliers in each group and best overall agreement is achieved at 61% using scaled data. In addition, we repeated this analysis by filtering out genes that are “undetected” in 25 or more samples. Results showing the distribution of agreement between Affy and TLDA using genes that are detected in 11 or more samples are tabulated in Table 9.

TABLE 9

| Re- | | | | Agree Down |
|---|---|---|---|---|
| moved | GAPDH | Agree All | Agree Up in F | in F |
| None | S | P: 53/101 (52%) | P: 38/57 (67%) | P: 15/44 (54%) |
| | | A: 26/43 (60%) | A: 17/24 (71%) | A: 9/19 (60%) |
| | | T: 78/144 (54%) | T: 56/81 (69%) | T: 24/63 (38%) |
| | U | P: 50/101 (50%) | P: 30/57 (53%) | P: 20/44 (45%) |
| | | A: 17/43 (40%) | A: 10/24 (42%) | A: 7/19 (37%) |
| | | T: 67/144 (47%) | T: 40/81 (49%) | T: 27/63 (43%) |
| One | S | P: 65/101 (64%) | P: 43/57 (75%) | P: 22/44 (50%) |
| | | A: 30/43 (70%) | A: 19/24 (79%) | A: 11/19 (58%) |
| | | T: 95/144 (66%) | T: 62/81 (77%) | T: 33/63 (52%) |
| | U | P: 54/101 (53%) | P: 47/57 (82%) | P: 7/44 (16%) |
| | | A: 24/43 (56%) | A: 19/24 (79%) | A: 5/19 (26%) |
| | | T: 78/144 (54%) | T: 66/81 (81%) | T: 12/63 (19%) |
| Two | S | P: 64/101 (63%) | P: 40/57 (70%) | P: 24/44 (55%) |
| | | A: 31/43 (71%) | A: 18/24 (75%) | A: 13/19 (68%) |
| | | T: 95/144 (66%) | T: 58/81 (72%) | T: 37/63 (59%) |
| | U | P: 55/101 (54%) | P: 52/57 (91%) | P: 3/44 (7%) |
| | | A: 29/43 (67%) | A: 24/24 | A: 5/19 (26%) |
| | | | (100%) | |
| | | T: 84/144 (60%) | T: 76/81 (94%) | T: 8/63 (13%) |

These results are further optimized as there is an overall 66% agreement when the top 1 or 2 outliers are removed on either side in both groups and scaled values are used. Also, of interest is that in unsealed values, almost all genes show upregulation in F group.

Prediction

In the prediction analysis, we used genes that are in agreement between Affy and TLDA when genes that are “undetected” in 25 or more samples are filtered out (Table 9). We applied leave one out cross validation using weighted voting. Best results were obtained when unsealed data was used (27/35=77% prediction accuracy) with 6 genes. In case of scaled data, best prediction accuracy was (22/35=63%). These genes along with their fold change value (F/N) in TLDA using 35 samples and in Affy is shown in Table 10, along with the fold change value (FIN) of these genes in “new” 14 samples.

TABLE 10
Six predictive genes and corresponding fold change values.

| | FC TLDA (F/N) | | FC TLDA (F/N) |
|---|---|---|---|
| Gene | 35 Samples | FC Affy | 14 Samples |
| DUSP1 | 4.61 | 6.10 | 11.49 |
| TGFB2 | 3.60 | 1.50 | 1.40 |
| SDF4 | 3.52 | 1.84 | 5.83 |
| SYMPK | 2.60 | 1.57 | 6.30 |
| NCAM1 | 2.51 | 2.12 | 5.41 |
| IDUA | 2.49 | 1.56 | 2.34 |

Prediction results for the 35 samples are given in Table 11. Incorrectly predicted samples are shaded. In total, 3 N and 5 F samples were predicted incorrectly.

TABLE 11
L1OXV prediction results for the “old” 35 samples.

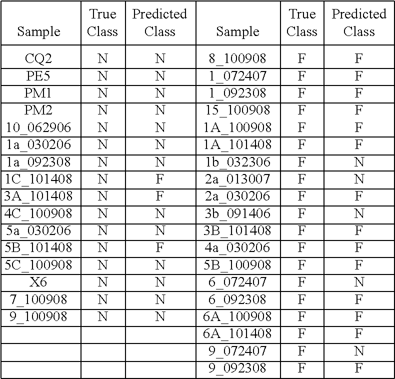

TABLE 12
List of 14 Preferred Pregnancy Signature Genes

| | True | Predicted |
|---|---|---|
| Sample Name | Class | Class |
| CQ2 | N | N |
| PE5 | N | N |
| PM1 | N | N |
| PM2 | N | N |
| 10_062906 | N | N |
| 1a_030206 | N | N |
| 1a_092308 | N | N |
| 1C_101408 | N | F |
| 3A_101408 | N | N |
| 4C_100908 | N | N |
| 5a_030206 | N | N |
| 5B_101408 | N | F |
| 5C_100908 | N | N |
| X6 | N | N |
| 7_100908 | N | N |
| 9_100908 | N | N |
| 10_100908 | N | N |
| 11_101408 | N | N |
| 1b_092308 | N | N |
| X4 | N | N |
| 5_101408 | N | F |
| 5C_101408 | N | N |
| 6_100908 | N | N |
| 8_101408 | N | F |
| 8_100908 | F | F |
| 1_072407 | F | F |
| 1_092308 | F | F |
| 15_100908 | F | F |
| 1A_100908 | F | F |
| 1A_101408 | F | F |
| 1b_032306 | F | N |
| 2a_013007 | F | N |
| 2a_030206 | F | F |
| 3b_091406 | F | N |
| 3B_101408 | F | F |
| 4a_030206 | F | N |
| 5B_100908 | F | N |
| 6_072407 | F | N |
| 6_092308 | F | F |
| 6A_100908 | F | F |
| 6A_101408 | F | F |
| 9_072407 | F | N |
| 9_092308 | F | N |
| 4_072407 | F | F |
| 08_092308CHP | F | F |
| 12_100908 | F | F |
| 1B_100908 | F | F |
| 4_100908 | F | N |
| 5a_013007 | F | N |
| Predictive | | |
| Genes | FC Affy | FC TLDA |
| ABCA6 | 1.73201 | 2.266364 |
| DDIT4 | 1.431242 | 3.590461 |
| DUSP1 | 6.097665 | 3.859997 |
| GPR137B | 1.351784 | 2.580321 |
| IDUA | 1.155538 | 1.877405 |
| KCTD5 | 1.18101 | 1.543389 |
| KRAS | 1.313773 | 1.686065 |
| NCAM1 | 2.121727 | 2.729792 |
| NDNL2 | 1.339368 | 3.989482 |
| OLFML3 | 4.039102 | 1.926399 |
| PTPRA | 3.192034 | 2.282193 |
| SDF4 | 1.84401 | 3.262687 |
| SLC26A3 | 1.097162 | 2.022467 |
| TERF2IP | 1.123738 | 2.363746 |

In conclusion, using the foregoing statistical methods we found that the level of expression of one or more genes in Table 4 and more preferably one or more of the 14 genes selected from the group consisting of ABCA6, NCAM1, OLFML3, PTPRA, SDF4, GPR137B, DDIT4, DUSP1, GPR137B, IDUA, KCTD5, NDNL2, SLC26A3, and TERF2IP by cumulus cells correlates to the capability of an oocyte associated therewith or from the same women donor to result in a viable pregnancy. Therefore, methods which detect the expression of one or more of these genes by a cumulus cell may be used in order to determine whether an oocyte associated therewith or from the same women donor is suitable for use in an IVF procedure, as well as for identifying individuals with conditions that result in oocytes unsuitable for use in IVF procedures, and for monitoring the success of fertility treatments.

### REFERENCES

Throughout this application, various references describe the state of the art to which this invention pertains. The disclosures of these references are hereby incorporated by reference into the present disclosure.

1. A non-invasive method of identifying oocytes that are capable of giving rise to a viable pregnancy when fertilized comprising the following steps:
(i) obtaining at least one cumulus cell associated with an oocyte that is to be tested for pregnancy competency from a female donor or for other oocytes of said donor;
(ii) assaying the expression of at least one gene by said at least one cumulus cell, the expression of which correlates to the capability of an oocyte associated with said cell to yield a viable pregnancy upon fertilization and transferal into a suitable uterine environment wherein said genes are selected from those in Table 4 and/or ABCA6, NCAM1, OLFML3, PTPRA, SDF4, GPR137B, DDIT4, DUSP1, GPR137B, IDUA, KCTD5, NDNL2, SLC26A3, and TERF2IP or their orthologs, splice or allelic variants; and
(iii) identifying, based on the level of expression of said at least one gene as compared to the characteristic level of expression by a cumulus cell associated with a pregnancy competent oocyte whether said oocytes or another oocyte derived from said female donor is potentially capable of yielding a viable pregnancy upon fertilization and transferal into a suitable uterine environment.

2. The method of claim 1 wherein the at least one gene the expression of which is detected is selected from the group consisting of ABCA6, NCAM1, OLFML3, PTPRA, SDF4, GPR137B, DDIT4, DUSP1, GPR137B, IDUA, KCTD5, NDNL2, SLC26A3, and TERF2IP.

3. The method of claim 2 wherein the method detects the expression of 2 or more of said genes.

4. The method of claim 2 wherein said method detects the expression of 3 or more f said genes.

5. The method of claim 2 wherein said method detects the expression of 4 or more of said genes.

6. The method of claim 2 wherein said method detects the expression of 5 or more of said genes.

7. The method of claim 2 wherein said method detects the expression of 6 or more of said genes.

8. The method of claim 2 wherein said method detects the expression of 7 or more of said genes.

9. The method of claim 2 wherein said method detects the expression of 8 or more of said genes.

10. The method of claim 1, wherein said oocyte is a mammalian oocyte.

11. The method of claim 10, wherein said oocytes is a human oocyte.

12. The method of claim 10, wherein said oocyte is a non-human primate oocyte.

13. The method of claim 1, wherein the expression of at least 5 genes are measured, the expression of which correlates to the capability of an oocyte to potentially yield a viable pregnancy are selected from ABCA6, NCAM1, OLFML3, PTPRA, SDF4, GPR137B, DDIT4, DUSP1, GPR137B, IDUA, KCTD5, NDNL2, SLC26A3, and TERF2IP.

14. The method of claim 13 wherein the expression of at least 6 genes are measured, the expression of which correlates to the capability of an oocyte to potentially yield a viable pregnancy are selected from ABCA6, NCAM1, OLFML3, PTPRA, SDF4, GPR137B, DDIT4, DUSP1, GPR137B, IDUA, KCTD5, NDNL2, SLC26A3, and TERF2IP.

15. The method of claim 14 wherein the expression of at least 7 genes are measured, the expression of which correlates to the capability of an oocyte to potentially yield a viable pregnancy are selected from ABCA6, NCAM1, OLFML3, PTPRA, SDF4, GPR137B, DDIT4, DUSP1, GPR137B, IDUA, KCTD5, NDNL2, SLC26A3, and TERF2IP.

16. The method of claim 15 wherein the expression of at least 8 genes are measured, the expression of which correlates to the capability of an oocyte to potentially yield a viable pregnancy are selected from ABCA6, NCAM1, OLFML3, PTPRA, SDF4, GPR137B, DDIT4, DUSP1, GPR137B, IDUA, KCTD5, NDNL2, SLC26A3, and TERF2IP.

17. The method of claim 14 wherein the expression of at least 9 genes are measured, the expression of which correlates to the capability of an oocyte to potentially yield a viable pregnancy are selected from ABCA6, NCAM1, OLFML3, PTPRA, SDF4, GPR137B, DDIT4, DUSP1, GPR137B, IDUA, KCTD5, NDNL2, SLC26A3, and TERF2IP.

18. The method of claim 14, wherein the expression of at least 10 genes, the expression of which correlates to the capability of an oocyte to potentially yield a viable pregnancy are measured.

19. The method of claim 1, wherein the expression of at least 15 genes, the expression of which correlates to the capability of an oocyte to potentially yield a viable pregnancy are identified.

20. The method of claim 1, wherein the expression of at least 20 genes, the expression of which correlates to the capability of an oocyte to potentially yield a viable pregnancy are identified.

21-65. (canceled)
